(19) United States
(12) Patent Application Publication
(10) Pub. No.: US 2026/0301703 A1
(43) Pub. Date: Oct. 1, 2026

(54) ADAPTIVE TEMPORAL ERROR DIFFUSION DITHERING FOR PRESENTING ANIMATION ON ELECTROPHORETIC DISPLAYS

(71) Applicant: E INK CORPORATION, Billerica, MA (US)

(72) Inventors: Manuel Jenkin JEROME, Boston, MA (US); Kenneth R. CROUNSE, Somerville, MA (US); Sarah PAYDAVOSI, Winchester, MA (US)

(21) Appl. No.: 19/631,746

(22) Filed: Mar. 27, 2026

Related U.S. Application Data
(60) Provisional application No. 63/781,241, filed on Mar. 31, 2025.

(51) Int. Cl. G09G 3/34; G09G 3/20

(52) U.S. Cl. CPC G09G 3/344; G09G 3/2048; G09G 3/2074; G09G 2300/0819; G09G 2300/0852; G09G 2320/0209; G09G 2320/0233; G09G 2320/0242; G09G 2320/0257; G09G 2320/0666; G09G 2360/16

(57) ABSTRACT

An electro-optic display and a method for driving an electro-optic display is described. The method includes choosing a size for a patch of pixel values and choosing a size for a correlation window of pixel values. The method also includes choosing a normalized damping factor set, computing a quantization alignment offset, and aligning a current image of an animation with the quantization alignment offset. The method also includes aligning a one or more diffusion images of an animation with the quantization alignment offset, computing a quantum correlation matrix for the pixels in the current image, and converting the quantum correlation matrix for the pixels in the current image into a plurality of temporal diffusion weights. The method also includes normalizing the quantum correlation matrix, performing spatial and temporal diffusion on the current image, and displaying an image of the animation based on the diffused current image.

### CROSS-REFERENCE TO RELATED APPLICATIONS

This application claims priority to U.S. Provisional Application No. 63/781,241, filed on Mar. 31, 2025, the entire contents of which are incorporated herein by reference. Further, the entire contents of any patent, published application, or other published work referenced herein are incorporated by reference in their entireties.

### FIELD OF THE INVENTION

The subject matter disclosed herein relates to methods for driving electro-optic displays, especially bistable electro-optic displays, and to apparatuses for carrying out such methods. More specifically, the subject matter disclosed herein relates to driving methods for displaying sequences of images on electrophoretic displays in rapid succession suitable for video or animation content.

### BACKGROUND OF THE INVENTION

An electrophoretic display (EPD) changes color by modifying the position of a charged colored particle with respect to a light-transmissive viewing surface. Such electrophoretic displays are typically referred to as “electronic paper” or “ePaper” because the resulting display has high contrast and is sunlight-readable, much like ink on paper. In the simplest sense, an electrophoretic display only requires a light-transmissive electrode at the viewing surface, a back electrode, and an electrophoretic medium including one or more types of charged colored particles. If the back electrode includes controllable regions (pixels)—either segmented electrodes or an active matrix of pixel electrodes controlled by transistors—a pattern can be made to appear electronically at the viewing surface. The pattern can be, for example, the text to a book.

A variety of color options have become commercially available for electrophoretic displays, including four-color displays (black, white, red, yellow; red, white, yellow, semi-transparent blue; cyan, yellow, magenta, white). Electrophoretic displays with four types of electrophoretic particles operate similar to the simple black and white displays EPDs when, for example, a single color matching the color of one of the particles is desired at the viewing surface. However, obtaining a broader color gamut, including mixed colors and process colors is more complicated and requires more exquisite control of the relative positions of the particles with respect to each other and the viewing surface. When done correctly, such four particle systems allow hundreds of different colors to be produced at each pixel. More details of such systems are available in the following U.S. patents, all of which are incorporated by reference in their entireties: U.S. Pat. Nos. 9,361,836, 9,921,451, 10,276,109, 10,353,266, 10,467,984, and 10,593,272.

Color electrophoretic displays can also be achieved using color filters arrays (CFA) disposed above or below a layer of electrophoretic display materials, for example a layer of microcapsules with black and white oppositely-charged particles that change position relative to a viewer due to a provided electric field. See, e.g., U.S. Pat. Nos. 8,098,418 and 10,444,592. However, electrophoretic displays incorporating CFAs suffer from loss of color spatial resolution due to subpixels. See, e.g., FIGS. 1D and 1E of the instant application, illustrating that a “pixel” (dashed bounding box) of a CFA-enabled display typically comprises at least three individually-controllable subpixels. Traditionally, CFA displays have red, green, and blue filters, however other complimentary sets of colors can be used. Because of the subpixels, if one of the primary colors is to be shown for a pixel of the display, the pixel has only one third or less (less because there is filling between subpixels) of the display area to be utilized for showing that color. The other subpixels are dark to increase the chromaticity of the desired color.

Of course, most color images require more than red, green, blue, black, and white pixels. While it is possible to approximate some colors (e.g., purple) with mixes of subpixels, a more common method is to dither the colors across the pixels in an image to achieve the desired color and shading. However, when dithering is used to increase the available colors in an electrophoretic display, the dithered subpixels involved in the dithering process may be subject to unwanted cross-talk with nearby subpixels, which can result in dithered colors looking “off.” See, e.g., U.S. Pat. No. 11,869,451. Additional problems arise when, e.g., only part of the image is updated (a.k.a. partial update), which can also result in colors on the non-updated edges on the border of the updated pixels looking “off.” See, e.g., U.S. Pat. No. 11,557,260.

Electro-optic displays typically have a backplane provided with a plurality of pixel electrodes each of which defines one pixel of the display. Each pixel electrode is typically disposed in a rectangular array of pixel electrodes and each pixel electrode is controlled with a thin-film transistor (TFT), and the TFTs are updated in a row-by-row fashion. Conventionally, a single common electrode extending over a large number of pixels, and normally the whole display is provided on the opposed side of the electro-optic medium. The individual pixel electrodes may be driven directly (i.e., a separate conductor may be provided to each pixel electrode) or the pixel electrodes may be driven in an active matrix manner which will be familiar to those skilled in backplane technology. Since adjacent pixel electrodes will often be at different voltages, they must be separated by inter-pixel gaps of finite width in order to avoid electrical shorting between electrodes. Although at first glance it might appear that the electro-optic medium overlying these gaps would not switch when drive voltages are applied to the pixel electrodes (and indeed, this is often the case with some non-bistable electro-optic media, such as liquid crystals, where a black mask is typically provided to hide these non-switching gaps), in the case of many bistable electro-optic media the medium overlying the gap does switch because of a phenomenon known as “blooming”.

Blooming refers to the tendency for application of a drive voltage to a pixel electrode to cause a change in the optical state of the electro-optic medium over an area larger than the physical size of the pixel electrode. An area of blooming is not a uniform color, but is typically a transition zone where, as one moves across the area of blooming, the color of the medium transitions from the desired color to another shade or color, for example a desired white pixel may include various shades of gray along the edges, a.k.a., “edge ghosting”. Furthermore, depending upon the type of display, i.e., black/white, color, black/white with color filter, the results of the edge ghosting can range from annoying to debilitating. In some cases, asymmetric blooming may contribute to edge ghosting.

Much of the discussion below will focus on methods for driving one or more pixel electrodes of an electro-optic display through a transition from a first optical (i.e., color) state to a final optical state (which may or may not be different from the initial optical state). The term “waveform” will be used to denote the entire voltage against time curve used to effect the transition from one specific first color state to a specific second color state. Typically such a waveform will comprise a plurality of waveform elements; where these elements are essentially rectangular (V×t) voltage pulses (i.e., where a given element comprises application of a constant voltage for a period of time); the elements may be called “pulses” or “drive pulses”. The term “drive scheme” denotes a set of waveforms sufficient to effect all possible transitions between gray levels for a specific display. A display may make use of more than one drive scheme; for example, the aforementioned U.S. Pat. No. 7,012,600 teaches that a drive scheme may need to be modified depending upon parameters such as the temperature of the display or the time for which it has been in operation during its lifetime, and thus a display may be provided with a plurality of different drive schemes to be used at differing temperature etc. A set of drive schemes used in this manner may be referred to as “a set of related drive schemes.” It is also possible, as described in several of the aforementioned MEDEOD applications, to use more than one drive scheme simultaneously in different areas of the same display, and a set of drive schemes used in this manner may be referred to as “a set of simultaneous drive schemes.”

The terms bistable and bistability are used herein in their conventional meaning in the art to refer to displays comprising display elements having first and second display states differing in at least one optical property, and such that after any given element has been driven, by means of an addressing pulse of finite duration, to assume either its first or second display state, after the addressing pulse has terminated, that state will persist for at least several times, for example at least four times, the minimum duration of the addressing pulse required to change the state of the display element. It is shown in U.S. Pat. No. 7,170,670 that some particle-based electrophoretic displays capable of gray scale are stable not only in their extreme black and white states but also in their intermediate gray states, and the same is true of some other types of electro-optic displays. This type of display is properly called multi-stable rather than bistable, although for convenience the term bistable may be used herein to cover both bistable and multi-stable displays. While the bistable nature of electrophoretic displays allows for massive power savings over traditional “always on” displays such as LCD and LED, the bistability can lead to image retention between updates, a.k.a. “ghosts”.

The term impulse, when used to refer to driving an electrophoretic display, is used herein to refer to the integral of the applied voltage with respect to time during the period in which the display is driven. The term waveform, when used to refer to driving an electrophoretic display, is used to describe a series or pattern of voltages provided to an electrophoretic medium over a given time period (seconds, frames, etc.) to produce a desired optical effect in the electrophoretic medium.

A particle that absorbs, scatters, or reflects light, either in a broad band or at selected wavelengths, is referred to herein as a colored or pigment particle. Various materials other than pigments (in the strict sense of that term as meaning insoluble colored materials) that absorb or reflect light, such as dyes or photonic crystals, etc., may also be used in the electrophoretic media and displays of the present invention.

Numerous patents and applications assigned to or in the names of the Massachusetts Institute of Technology (MIT) and E Ink Corporation describe various technologies used in encapsulated electrophoretic and other electro-optic media. Such encapsulated media comprise numerous small capsules, each of which itself comprises an internal phase containing electrophoretically-mobile particles in a fluid medium, and a capsule wall surrounding the internal phase. Typically, the capsules are themselves held within a polymeric binder to form a coherent layer positioned between two electrodes. The technologies described in these patents and applications include:
(a) Electrophoretic particles, fluids and fluid additives; see for example U.S. Pat. Nos. 7,002,728 and 7,679,814;
(b) Capsules, binders and encapsulation processes; see for example U.S. Pat. Nos. 6,922,276 and 7,411,719;
(c) Microcell structures, wall materials, and methods of forming microcells; see for example U.S. Pat. Nos. 7,072,095 and 9,279,906;
(d) Methods for filling and sealing microcells; see for example U.S. Pat. Nos. 7,144,942 and 7,715,088;
(e) Films and sub-assemblies containing electro-optic materials; see for example U.S. Pat. Nos. 6,982,178 and 7,839,564;
(f) Backplanes, adhesive layers and other auxiliary layers and methods used in displays; see for example U.S. Pat. Nos. 7,116,318 and 7,535,624;
(g) Color formation color adjustment; see for example U.S. Pat. Nos. 6,017,584; 6,545,797; 6,664,944; 6,788,452; 6,864,875; 6,914,714; 6,972,893; 7,038,656; 7,038,670; 7,046,228; 7,052,571; 7,075,502; 7,167,155; 7,385,751; 7,492,505; 7,667,684; 7,684,108; 7,791,789; 7,800,813; 7,821,702; 7,839,564; 7,910,175; 7,952,790; 7,956,841; 7,982,941; 8,040,594; 8,054,526; 8,098,418; 8,159,636; 8,213,076; 8,363,299; 8,422,116; 8,441,714; 8,441,716; 8,466,852; 8,503,063; 8,576,470; 8,576,475; 8,593,721; 8,605,354; 8,649,084; 8,670,174; 8,704,756; 8,717,664; 8,786,935; 8,797,634; 8,810,899; 8,830,559; 8,873,129; 8,902,153; 8,902,491; 8,917,439; 8,964,282; 9,013,783; 9,116,412; 9,146,439; 9,164,207; 9,170,467; 9,170,468; 9,182,646; 9,195,111; 9,199,441; 9,268,191; 9,285,649; 9,293,511; 9,341,916; 9,360,733; 9,361,836; 9,383,623; and 9,423,666; and U.S. Patent Applications Publication Nos. 2008/0043318; 2008/0048970; 2009/0225398; 2010/0156780; 2011/0043543; 2012/0326957; 2013/0242378; 2013/0278995; 2014/0055840; 2014/0078576; 2014/0340430; 2014/0340736; 2014/0362213; 2015/0103394; 2015/0118390; 2015/0124345; 2015/0198858; 2015/0234250; 2015/0268531; 2015/0301246; 2016/0011484; 2016/0026062; 2016/0048054; 2016/0116816; 2016/0116818; and 2016/0140909;
(h) Methods for driving displays; see for example U.S. Pat. Nos. 5,930,026; 6,445,489; 6,504,524; 6,512,354; 6,531,997; 6,753,999; 6,825,970; 6,900,851; 6,995,550; 7,012,600; 7,023,420; 7,034,783; 7,061,166; 7,061,662; 7,116,466; 7,119,772; 7,177,066; 7,193,625; 7,202,847; 7,242,514; 7,259,744; 7,304,787; 7,312,794; 7,327,511; 7,408,699; 7,453,445; 7,492,339; 7,528,822; 7,545,358; 7,583,251; 7,602,374; 7,612,760; 7,679,599; 7,679,813; 7,683,606; 7,688,297; 7,729,039; 7,733,311; 7,733,335; 7,787,169; 7,859,742; 7,952,557; 7,956,841; 7,982,479; 7,999,787; 8,077,141; 8,125,501; 8,139,050; 8,174,490; 8,243,013; 8,274,472; 8,289,250; 8,300,006; 8,305,341; 8,314,784; 8,373,649; 8,384,658; 8,456,414; 8,462,102; 8,514,168; 8,537,105; 8,558,783; 8,558,785; 8,558,786; 8,558,855; 8,576,164; 8,576,259; 8,593,396; 8,605,032; 8,643,595; 8,665,206; 8,681,191; 8,730,153; 8,810,525; 8,928,562; 8,928,641; 8,976,444; 9,013,394; 9,019,197; 9,019,198; 9,019,318; 9,082,352; 9,171,508; 9,218,773; 9,224,338; 9,224,342; 9,224,344; 9,230,492; 9,251,736; 9,262,973; 9,269,311; 9,299,294; 9,373,289; 9,390,066; 9,390,661; and 9,412,314; and U.S. Patent Applications Publication Nos. 2003/0102858; 2004/0246562; 2005/0253777; 2007/0091418; 2007/0103427; 2007/0176912; 2008/0024429; 2008/0024482; 2008/0136774; 2008/0291129; 2008/0303780; 2009/0174651; 2009/0195568; 2009/0322721; 2010/0194733; 2010/0194789; 2010/0220121; 2010/0265561; 2010/0283804; 2011/0063314; 2011/0175875; 2011/0193840; 2011/0193841; 2011/0199671; 2011/0221740; 2012/0001957; 2012/0098740; 2013/0063333; 2013/0194250; 2013/0249782; 2013/0321278; 2014/0009817; 2014/0085355; 2014/0204012; 2014/0218277; 2014/0240210; 2014/0240373; 2014/0253425; 2014/0292830; 2014/0293398; 2014/0333685; 2014/0340734; 2015/0070744; 2015/0097877; 2015/0109283; 2015/0213749; 2015/0213765; 2015/0221257; 2015/0262255; 2015/0262551; 2016/0071465; 2016/0078820; 2016/0093253; 2016/0140910; and 2016/0180777;
(i) Applications of displays; see for example U.S. Pat. Nos. 7,312,784 and 8,009,348; and
(j) Non-electrophoretic displays, as described in U.S. Pat. No. 6,241,921; and U.S. Patent Applications Publication Nos. 2015/0277160; and U.S. Patent Application Publications Nos. 2015/0005720 and 2016/0012710.

Many of the aforementioned patents and applications recognize that the walls surrounding the discrete microcapsules in an encapsulated electrophoretic medium could be replaced by a continuous phase, thus producing a so-called polymer-dispersed electrophoretic display, in which the electrophoretic medium comprises a plurality of discrete droplets of an electrophoretic fluid and a continuous phase of a polymeric material, and that the discrete droplets of electrophoretic fluid within such a polymer-dispersed electrophoretic display may be regarded as capsules or microcapsules even though no discrete capsule membrane is associated with each individual droplet; see for example, U.S. Pat. No. 6,866,760. Accordingly, for purposes of the present application, such polymer-dispersed electrophoretic media are regarded as sub-species of encapsulated electrophoretic media.

A related type of electrophoretic display is a so-called microcell electrophoretic display. In a microcell electrophoretic display, the charged particles and the fluid are not encapsulated within microcapsules but instead are retained within a plurality of cavities formed within a carrier medium, typically a polymeric film. See, for example, U.S. Pat. Nos. 6,672,921 and 6,788,449.

Although electrophoretic media are often opaque (since, for example, in many electrophoretic media, the particles substantially block transmission of visible light through the display) and operate in a reflective mode, many electrophoretic displays can be made to operate in a so-called shutter mode in which one display state is substantially opaque and one is light-transmissive. See, for example, U.S. Pat. Nos. 5,872,552; 6,130,774; 6,144,361; 6,172,798; 6,271,823; 6,225,971; and 6,184,856. Dielectrophoretic displays, which are similar to electrophoretic displays but rely upon variations in electric field strength, can operate in a similar mode; see U.S. Pat. No. 4,418,346. Other types of electro-optic displays may also be capable of operating in shutter mode. Electro-optic media operating in shutter mode can be used in multi-layer structures for full color displays; in such structures, at least one layer adjacent the viewing surface of the display operates in shutter mode to expose or conceal a second layer more distant from the viewing surface.

An encapsulated electrophoretic display typically does not suffer from the clustering and settling failure mode of traditional electrophoretic devices and provides further advantages, such as the ability to print or coat the display on a wide variety of flexible and rigid substrates. (Use of the word printing is intended to include all forms of printing and coating, including, but without limitation: pre-metered coatings such as patch die coating, slot or extrusion coating, slide or cascade coating, curtain coating; roll coating such as knife over roll coating, forward and reverse roll coating; gravure coating; dip coating; spray coating; meniscus coating; spin coating; brush coating; air knife coating; silk screen printing processes; electrostatic printing processes; thermal printing processes; ink jet printing processes; electrophoretic deposition (See U.S. Pat. No. 7,339,715); and other similar techniques.) Thus, the resulting display can be flexible. Further, because the display medium can be printed (using a variety of methods), the display itself can be made inexpensively. Additionally, as described in US Patent Application Publication No. 2021/0132459, encapsulated electrophoretic media can be incorporated into non-planar surfaces that are, in turn, incorporated into everyday objects. As a result, surfaces of products, building materials, etc. can be engineered to change color when a suitable electric field is supplied.

For the most part, electrophoretic media, such as described above, are designed to be driven with low voltage square waves, such as produced by a driver circuit from a thin-film-transistor backplane. Such driver circuits can be inexpensively mass-produced because they are very closely related to the driving circuitry and fabrication methods that are used to produce liquid crystal display panels, such as found in smart phones, laptop monitors, and televisions. Historically, even when electrophoretic media are driven directly via an isolated electrode (e.g., segmented electrode) the driving pulses are delivered as square waves, having an amplitude and a time width. See, for example, U.S. Pat. No. 7,012,600, incorporated by reference in its entirety. Typically, for an active matrix backplane including an array of pixel electrodes, each pixel electrode will receive a signal pulse (square wave) for a short period of time as the array of pixel electrodes are addressed in a line-by-line fashion. The period of time that it takes to update the entire array of pixels, and also the time between updates of an individual pixel electrode is known as a frame. The collection of voltage impulses required to change the display from a first display state to a second state is generally known as a waveform. A waveform typically includes at least three frames, e.g., as described in U.S. Pat. No. 11,620,959, which is incorporated by reference in its entirety.

The optical state of an electrophoretic display panel at a given time typically depends, in some part, on its prior optical state(s). For example, for a given pixel of an electrophoretic display, the actual optical state of the pixel can be affected by the electric fields that have previously been applied to the electrophoretic medium adjacent to the pixel. Parameters such as the order, length, and magnitude of the impulses of in the prior waveforms used to drive the pixel, the electric field intensity generated by those waveforms, and the elapsed time between successive image updates can all influence the optical state of a pixel. Further, when two or more pixels are undergoing different optical transitions, some cross-talk can be present that can affect the optical states of nearby pixels. Accordingly, it has historically been challenging to display visually-engaging videos, animation sequences, or quick image transitions on electrophoretic display panels because of the history-dependent nature of such panels.

Ghosting is one of the artifacts that is most commonly observed when sequences of images are displayed in rapid succession on electrophoretic displays. In particular, ghosting can manifest as remnants of text or objects that were present in previous images being visible in the currently-displayed image. Ghosting is particularly observable in regions of the display that remain constant or change slowly during a video. This is primarily because the actual optical state of such pixels can depend on the prior update history of the display, and therefore most pixels include deviations from an ideal or expected optical state due to insufficient clearing.

Some conventional methods seek to mitigate prior image based ghosting by applying DC imbalanced clearing pulses to regions of the display that are expected to have ghosting artifacts based on the previous image transitions that have occurred. However, this solution induces remnant voltage buildup that can harm the backplane components and reduce the working lifetime of the display. Further, the DC imbalanced clearing pulses can result in optical transitions that are visibly jarring to a user, also known as “flashy updates.”

Other conventional mitigation methods use driving waveforms that incorporate one or more clearing sequences designed to put the electrophoretic medium in a known state. For example, prior to updating the display with a new image, the charged particles can all be driven to one or both of the extreme optical states/rails (e.g., black, white), once or multiple times. However, this solution often results in the visibly jarring flashy updates mentioned above. This solution also requires waveforms that are typically longer in duration to accommodate the clearing sequence between images, thereby leading to update rates unsuitable for displaying sequences of images such as video or animation content.

In an effort to increase response rate, waveforms from driving schemes such as A2 or DU resort to 1 bit, or few bits, of achievable precision for the state of each pixel, but this introduces tradeoffs in contrast and image fidelity. Using a 1-bit driving scheme in which the waveforms inherently drive to one of the rails can be especially helpful in reducing ghosting if longer pulse lengths are utilized. However, due to the prior state history dependency and cross-talk issues discussed above, ghosting artifacts can still appear, especially when update times are shortened to be able to display video or animation content.

Dithering is a technique used to display images with a broader color range (or range of gray tone levels) by using the limited colors available on the display. This process is a form of quantization that aims to match the average color values of the output achievable with the available colors to the average color values of the input image. The size of the area over which this averaging occurs varies based on the specific algorithm and implementation used. As indicated above, dithering is commonly used to display colors (including gray states) from a source image that are outside of the available gamut of colors a display is capable of presenting. Several dithering techniques exist such as thresholding, mask-based dithering, error diffusion dithering, etc., each having its own tradeoffs between resolution and artifact suppression.

Mask based dithering can be an effective technique for adding noise to an image to make the effects of the quantization less perceivable to the human eye. However, mask based dithering effectively reduces the resolution of the image and also introduces banding or blocking artifacts in subtle color gradients as well as visible patterns.

Other algorithms may employ error diffusion, a technique in which error resulting from the difference between the color required at a certain pixel and the closest color in the per-pixel palette (also referred to as the quantization residual, residual error, or simply error) is distributed to neighboring pixels that have not yet been processed.

Floyd-Steinberg dithering is an example of an error diffusion technique commonly used by image processors. The algorithm achieves dithering by diffusing the residual error of a pixel (i.e., the difference between the quantized pixel value and the desired pixel value) to its neighboring pixels, according to a weighted distribution:

$$\frac{1}{16} [ \begin{matrix}- & \# & 7 \\ 3 & 5 & 1\end{matrix} ]$$

where “-” denotes a pixel in the current row which has already been processed (hence diffusing an error to it is not possible), and “#” denotes the pixel currently being processed by the dithering algorithm.

The algorithm scans the image from left to right, top to bottom, processing pixel values one by one. For each pixel processed, a fraction of the residual error is transferred to the neighboring pixels in an amount according to the kernel weights above, while not affecting the pixels that have already been processed. Hence, if a number of pixels have been rounded downwards by the quantization process, the largest proportion of the residual error is diffused in a manner that it becomes more likely that the next pixel is rounded upwards, such that on average, the error is normalized to be close to zero.

Error diffusion dithering achieves better resolution than mask based dithering, and its chaotic pattern tends to produce smoother gradients between colors and sharper contours between objects in the image. However, error diffusion dithering can introduce other artifacts such as color leakage, and in some instances, the sharp contours caused by the chaotic pattern can also make artifacts more pronounced. Further, the statistical nature of noise between images can create time varying patterns that can be visually distracting. Discounting some of the error from the error diffusion kernel (e.g., diffusing only a fraction of the residual error to neighboring pixels) can suppress this noise. For example, diffusing just 90% of the residual error to neighboring pixels reduces the occurrence of visual artifacts, albeit at the expense of reduced resolution due to information loss.

Accordingly, the presently available methods for displaying sequences of images in rapid succession suitable for video or animation content each include tradeoffs in image quality and/or user experience due to varying degrees of flicker/flash during updates, response rates/update times, ghosting, DC imbalance, and image contrast/fidelity.

### SUMMARY OF THE INVENTION

Accordingly, there is a need for driving methods for displaying sequences of images on electrophoretic displays in rapid succession suitable for video or animation content.

In one aspect, the subject matter herein includes a method for driving an electro-optic display having a plurality of display pixels. The method includes choosing a size for a patch of pixel values, and choosing a size for a correlation window of pixel values. The method also includes choosing a normalized damping factor set, and computing a quantization alignment offset. The method also includes aligning a current image of an animation with the quantization alignment offset, and aligning a one or more diffusion images of an animation with the quantization alignment offset. The method also includes computing a quantum correlation matrix for the pixels in the current image, and converting the quantum correlation matrix for the pixels in the current image into a plurality of temporal diffusion weights. The method also includes normalizing the quantum correlation matrix, performing spatial and temporal diffusion on the current image, and displaying an image of the animation based on the diffused current image.

In some embodiments, aligning the current image using the quantization alignment offset includes subtracting the QAO from the value of each pixel in the current image. In some embodiments, aligning the one or more diffusion images of an animation using the quantization alignment offset includes subtracting the quantization alignment offset from the value of each pixel in the one or more diffusion images.

In some embodiments, computing the quantum correlation matrix for each pixel in the current image includes cross-correlating the patch of pixel values with the correlation window of pixel values.

In some embodiments, computing the quantization alignment offset includes computing a pixel alignment offset for each pixel in the current image, and determining the mean of the pixel alignment offset for each pixel in the current image.

In some embodiments, computing the pixel alignment offset includes: computing a first sum where the first sum includes (i) the product of a first quantization state value and a first factor of the normalized damping factor set, and (ii) the product of a second quantization state value and a second factor of the normalized damping factor set, and dividing the first sum by the sum of the first and second factors of the normalized damping factor set.

In some embodiments, the size of the patch of pixel values is smaller than the size of the correlation window of pixel values. In some embodiments, the normalized damping factor set includes a first factor corresponding to a first quantization state value, and a second factor corresponding to a second quantization state value. In some embodiments, the first factor is less than the second factor. In some embodiments, the first quantization state value is less than the second quantization state value.

### BRIEF DESCRIPTION OF DRAWINGS

Additional details of one or more embodiments of the subject matter described in this specification are set forth in the accompanying drawings and the description below. Other features, aspects, and advantages of the subject matter will become apparent from the descriptions contained herein and the accompanying drawings. The drawings are not necessarily to scale and elements of similar structures are generally annotated with like reference numerals for illustrative purposes throughout the drawings. However, the specific properties and functions of elements in different embodiments may not be identical. Further, the drawings are only intended to facilitate the description of the subject matter. The drawings do not illustrate every aspect of the described embodiments and do not limit the scope of the present disclosure or claims.

FIG. 1A is a representative cross-section of a four-particle electrophoretic display wherein the electrophoretic medium is encapsulated in microcapsules.

FIG. 1B is a representative cross-section of a four-particle electrophoretic display wherein the electrophoretic medium is encapsulated in microcells.

FIG. 1C is a representative cross-section of an electrophoretic display, e.g., including an electrophoretic layer of oppositely charged black and white particles, coupled to a color filter array (CFA) disposed between the electrophoretic layer and the viewer.

FIG. 1D is an exemplary RGBW color filter array pattern that can be used with a CFA-enabled color electrophoretic display. The dashed line defines a “pixel” for the purposes of defining a pixel in an image. Each pixel of the RGBW CFA includes an independently controllable red, green, and blue partially-transmissive filter portion, known as a “subpixel”; a clear (a.k.a. white) subpixel helps to improve white and light colors in an image. Below each subpixel is an independently-controllable pixel electrode of the type shown in FIG. 2B.

FIG. 1E is an exemplary RGB color filter array pattern that can be used with a CFA-enabled color electrophoretic display. The dashed line defines a “pixel” for the purposes of defining a pixel in an image. Each pixel of the RGB CFA includes an independently controllable red, green, and blue partially-transmissive filter portion, known as a subpixel; a portion around each subpixel is clear (a.k.a., partial fill CFA) in order to improve white and light colors in an image, but with higher overall resolution that in FIG. 1D. Below each subpixel is an independently-controllable pixel electrode of the type shown in FIG. 2B.

FIG. 2A illustrates an exemplary equivalent circuit of a single pixel of an electrophoretic display that uses an active matrix backplane with a storage capacitor.

FIG. 2B illustrates an exemplary equivalent circuit of a simplified electrophoretic display of the invention, allowing driving in a row-column format.

FIG. 3 illustrates an exemplary electrophoretic display that includes a display module. The electrophoretic display also includes a processor, memory, one or more power supplies, and a controller. The electrophoretic display may also include sensors to allow the electrophoretic display to adjust operational parameters based upon the ambient environment, e.g., temperature and illumination.

FIG. 4A illustrates the preferred position of each of the four sets of particles to produce eight standard colors in a white-cyan-magenta-yellow (WCMY) four-particle electrophoretic display, wherein the white particles are reflective and the cyan, magenta, and yellow particles are absorptive.

FIG. 4B illustrates the preferred position of each of the four sets of particles to produce seven standard colors in a white-red-yellow-blue semi-absorptive (WRYB*) four-particle electrophoretic display, wherein the white, red, and yellow particles are reflective and the blue particle is semi-absorptive (B*).

FIG. 5 is a flow diagram detailing the steps of a method for adaptive temporal error diffusion dithering for presenting animation on electrophoretic displays.

### DETAILED DESCRIPTION OF THE INVENTION

Electrophoretic displays and methods for fabricating electrophoretic displays including two, three, four (or more) particles have been discussed in the prior art. The electrophoretic fluid may be encapsulated in microcapsules or incorporated into microcell structures that are thereafter sealed with a polymeric layer. The microcapsule or microcell layers may be coated or laminated to a plastic substrate or film bearing a transparent coating of an electrically conductive material. Alternatively, the microcapsules may be coated onto a light transmissive substrate or other electrode material using spraying techniques. (See U.S. Pat. No. 9,835,925, incorporated by reference herein). The resulting assembly may be laminated to a backplane including pixel electrodes using an electrically conductive adhesive. The assembly may alternatively be attached to one or more segmented electrodes on a backplane, wherein the segmented electrodes are driven directly. In another embodiment the assembly, which may include a non-planar light transmissive electrode material is spray coated with capsules and then overcoated with a back electrode material. (See U.S. Patent Publication No. 2021/0132459, incorporated by reference herein.) Alternatively, the electrophoretic fluid may be dispensed directly on a thin open-cell grid that has been arranged on a backplane including an active matrix of pixel electrodes. The filled grid can then be top-sealed with an integrated protective sheet/light-transmissive electrode.

An electrophoretic display normally comprises a layer of electrophoretic material and at least two other layers disposed on opposed sides of the electrophoretic material, one of these two layers being an electrode layer. In most such displays both the layers are electrode layers, and one or both of the electrode layers are patterned to define the pixels of the display. For example, one electrode layer may be patterned into elongate row electrodes and the other into elongate column electrodes running at right angles to the row electrodes, the pixels being defined by the intersections of the row and column electrodes. Alternatively, and more commonly, one electrode layer has the form of a single continuous electrode and the other electrode layer is patterned into a matrix of pixel electrodes, each of which defines one pixel of the display. In another type of electrophoretic display, which is intended for use with a stylus, print head or similar movable electrode separate from the display, only one of the layers adjacent the electrophoretic layer comprises an electrode, the layer on the opposed side of the electrophoretic layer typically being a protective layer intended to prevent the movable electrode damaging the electrophoretic layer.

Electrophoretic media used herein include charged particles that vary in color, reflective or absorptive properties, charge density, and mobility in an electric field (measured as a zeta potential). A particle that absorbs, scatters, or reflects light, either in a broad band or at selected wavelengths, is referred to herein as a colored or pigment particle. Various materials other than pigments (in the strict sense of that term as meaning insoluble colored materials) that absorb or reflect light, such as dyes or photonic crystals, etc., may also be used in the electrophoretic media and displays of the present invention. For example, the electrophoretic medium might include a fluid, a plurality of first and a plurality of second particles dispersed in the fluid, the first and second particles bearing charges of opposite polarity, the first particle being a light-scattering particle and the second particle having one of the subtractive primary colors, and a plurality of third and a plurality of fourth particles dispersed in the fluid, the third and fourth particles bearing charges of opposite polarity, the third and fourth particles each having a subtractive primary color different from each other and from the second particles, wherein the electric field required to separate an aggregate formed by the third and the fourth particles is greater than that required to separate an aggregate formed from any other two types of particles.

The electrophoretic media of the present invention may contain any of the additives used in prior art electrophoretic media as described for example in the E Ink and MIT patents and applications mentioned above. Thus, for example, the electrophoretic medium of the present invention will typically comprise at least one charge control agent to control the charge on the various particles, and the fluid may have dissolved or dispersed therein a polymer having a number average molecular weight in excess of about 20,000 and being essentially non-absorbing on the particles to improves the bistability of the display, as described in the aforementioned U.S. Pat. No. 7,170,670.

In one embodiment, the present invention uses a light-scattering particle, typically white, and three substantially non-light-scattering particles. There is of course no such thing as a completely light-scattering particle or a completely non-light-scattering particle, and the minimum degree of light scattering of the light-scattering particle, and the maximum tolerable degree of light scattering tolerable in the substantially non-light-scattering particles, used in the electrophoretic of the present invention may vary somewhat depending upon factors such as the exact pigments used, their colors and the ability of the user or application to tolerate some deviation from ideal desired colors. The scattering and absorption characteristics of a pigment may be assessed by measurement of the diffuse reflectance of a sample of the pigment dispersed in an appropriate matrix or liquid against white and dark backgrounds. Results from such measurements can be interpreted according to a number of models that are well-known in the art, for example, the one-dimensional Kubelka-Munk treatment. In the present invention, it is preferred that the white pigment exhibit a diffuse reflectance at 550 nm, measured over a black background, of at least 5% when the pigment is approximately isotropically distributed at 15% by volume in a layer of thickness 1 μm comprising the pigment and a liquid of refractive index less than 1.55. The yellow, magenta and cyan pigments preferably exhibit diffuse reflectances at 650, 650 and 450 nm, respectively, measured over a black background, of less than 2.5% under the same conditions. (The wavelengths chosen above for measurement of the yellow, magenta and cyan pigments correspond to spectral regions of minimal absorption by these pigments.) Colored pigments meeting these criteria are hereinafter referred to as “non-scattering” or “substantially non-light-scattering”. Specific examples of suitable particles are disclosed in U.S. Pat. No. 9,921,451, which is incorporated by reference herein.

Alternative particle sets may also be used, including four sets of reflective particles, or one absorptive particle with three or four sets of different reflective particles, i.e., such as described in U.S. Pat. Nos. 9,922,603 and 10,032,419, which are incorporated by reference herein. For example, white particles may be formed from an inorganic pigment, such as TiO₂, ZrO₂, ZnO, Al₂O₃, Sb₂O₃, BaSO₄, PbSO₄ or the like, while black particles may be formed from CI pigment black 26 or 28 or the like (e.g., manganese ferrite black spinel or copper chromite black spinel) or carbon black. The third/fourth/fifth type of particles may be of a color such as red, green, blue, magenta, cyan or yellow. The pigments for this type of particles may include, but are not limited to, CI pigment PR 254, PR122, PR149, PG36, PG58, PG7, PB28, PB15:3, PY138, PY150, PY155 or PY20. Specific examples include Clariant Hostaperm Red D3G 70-EDS, Hostaperm Pink E-EDS, PV fast red D3G, Hostaperm red D3G 70, Hostaperm Blue B2G-EDS, Hostaperm Yellow H4G-EDS, Hostaperm Green GNX, BASF Irgazine red L 3630, Cinquasia Red L 4100 HD, and Irgazin Red L 3660 HD; Sun Chemical phthalocyanine blue, phthalocyanine green, diarylide yellow or diarylide AAOT yellow.

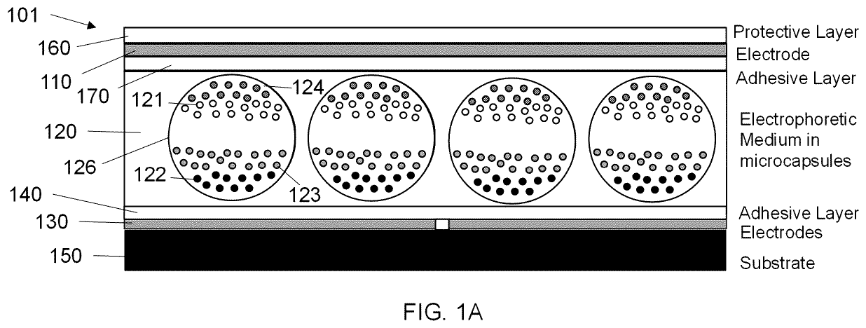

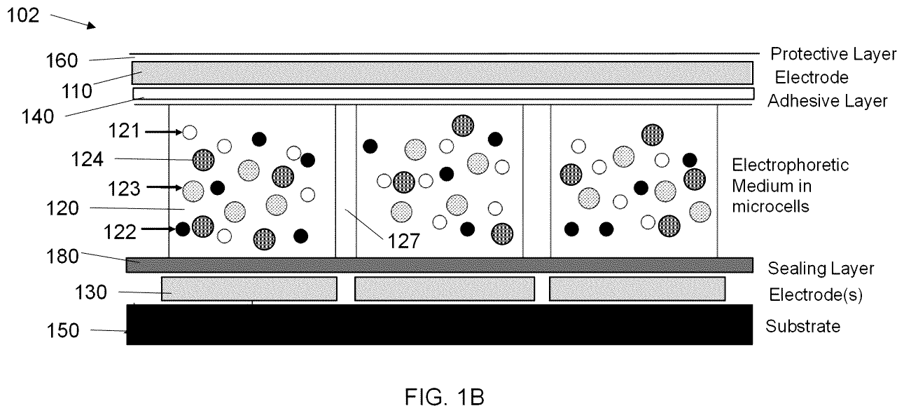

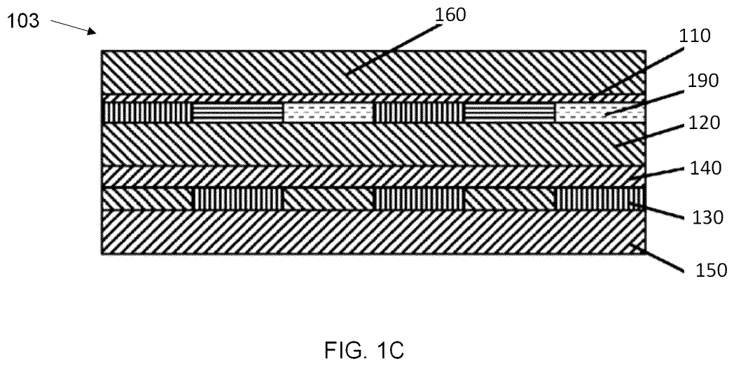

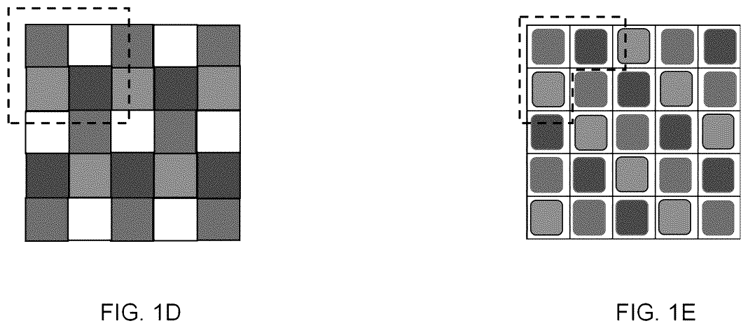

As shown in FIGS. 1A, 1B, and 1C, an electrophoretic display (101, 102, 103) typically includes a top transparent electrode 110, an electrophoretic medium 120, and a bottom electrode 130, which is often a pixel electrode of an active matrix of pixels controlled with thin film transistors (TFT). However, the bottom electrode 130 can be a singular larger electrode, such as a graphite backplane, a film of PET/ITO, a metalized film, or a conductive paint. In the electrophoretic media 120 described in FIGS. 1A and 1B, there are four different types of particles, 121, 122, 123, and 124, however more particle sets can be used with the methods and displays described herein. In the CFA display 103, the electrophoretic medium 120 may include an encapsulated electrophoretic medium with only black and white oppositely-charged particles. FIG. 1D is an exemplary RGBW color filter array pattern that can be incorporated in a CFA display 103. The colored elements may be provided directly the top transparent electrode 110, which may be, for example, indium-tin-oxide (ITO). Such CFA films are available from Toppan Printing (Japan). Alternatively, the color filter elements may be applied to the electrophoretic media 120 with an ink-jet or other precision printing process. See U.S. Pat. No. 10,209,556. As shown in FIGS. 1D and 1E, the dashed line defines a “pixel” for the purposes of defining a pixel in an image. In FIG. 1D, each pixel of the RGBW CFA includes independently-controllable red, green, and blue subpixels and an equally-sized clear (a.k.a. white) subpixel to improve white and lighter colors in an image. In FIG. 1E, pixel of the RGB CFA includes independently-controllable red, green, and blue subpixel with a portion around each subpixel being clear (a.k.a., partial fill CFA) in order to improve white and light colors in an image. In practice CFA patterns of FIG. 1E are preferred over the patterns of FIG. 1D because each image pixel is slightly smaller and thus a higher resolution can be achieved for the same number of pixel electrodes per inch (PPI), typically between 100 and 400 PPI, more commonly between 150 and 300 PPI.

In FIGS. 1A and 1B and similar embodiments, two of the four different types of particle sets, 121, 122, 123, and 124 are of first polarity, while the other two sets are of a second (opposite) polarity. In some embodiments, one of the four different types of particle sets, 121, 122, 123, and 124 is of first polarity, while the other three sets are of a second (opposite) polarity. In some embodiments two of the four different types of particle sets are of a first polarity, while the other two sets are of an opposite polarity. The electrophoretic medium 120 is typically compartmentalized such by a microcapsule 126 or the walls of a microcell 127. An optional adhesive layer 140 can be disposed adjacent any of the layers, however, it is typically adjacent an electrode layer (110 or 130). There may be more than one adhesive layer 140 in a given electrophoretic display (105, 106), however only one layer is more common. The entire display stack is typically disposed on a substrate 150, which may be rigid or flexible. The display (101, 102) typically also includes a protective layer 160, which may simply protect the top electrode 110 from damage, or it may envelop the entire display (101, 102) to prevent ingress of water, etc. Electrophoretic displays (101, 102) may also include sealing layers 180 as needed. In some embodiments the adhesive layer 140 may include a primer component to improve adhesion to the electrode layer 110, or a separate primer layer (not shown in FIG. 1B) may be used. The structures of electrophoretic displays and the component parts, pigments, adhesives, electrode materials, etc., are described in many patents and patent applications published by E Ink Corporation, such as U.S. Pat. Nos. 6,922,276; 7,002,728; 7,072,095; 7,116,318; 7,715,088; and 7,839,564, all of which are incorporated by reference herein in their entireties.

In some embodiments, e.g., as shown in FIG. 1A, the electrophoretic display may include only a first light-transmissive electrode, an electrophoretic medium, and a second (rear) electrode, which may also be light-transmissive. However, to produce a high-resolution display, e.g., as shown in FIG. 1B. Of course, each pixel must be addressable without interference from adjacent pixels so that an image file is faithfully reproduced in the display. One way to achieve this objective is to provide an array of non-linear elements, such as transistors or diodes, with at least one non-linear element associated with each pixel, to produce an “active matrix” display. An addressing or pixel electrode, which addresses one pixel, is connected to an appropriate voltage source through the associated non-linear element. Typically, when the non-linear element is a transistor, the pixel electrode is connected to the drain of the transistor, and this arrangement will be assumed in the following description, although it is essentially arbitrary and the pixel electrode could be connected to the source of the transistor. Conventionally, in high resolution arrays, the pixels are arranged in a two-dimensional array of rows and columns, such that any specific pixel is uniquely defined by the intersection of one specified row and one specified column. The sources of all the transistors in each column are connected to a single column electrode, while the gates of all the transistors in each row are connected to a single row electrode; again the assignment of sources to rows and gates to columns is conventional but essentially arbitrary, and could be reversed if desired. The row electrodes are connected to a row driver, which essentially ensures that at any given moment only one row is selected, i.e., that there is applied to the selected row electrode a select voltage such as to ensure that all the transistors in the selected row are conductive, while there is applied to all other rows a non-select voltage such as to ensure that all the transistors in these non-selected rows remain non-conductive. The column electrodes are connected to column drivers, which place upon the various column electrodes voltages selected to drive the pixels in the selected row to their desired optical states. (The aforementioned voltages are relative to a common front electrode which is conventionally provided on the opposed side of the electro-optic medium from the non-linear array and extends across the whole display.)

After a pre-selected interval known as the “line address time” the selected row is deselected, the next row is selected, and the voltages on the column drivers are changed so that the next line of the display is written. This process is repeated so that the entire display is written in a row-by-row manner. The entire process is coordinated with a clock circuit. The time between addressing a pixel for the nth time and the following addressing, n+1, is known as a “frame.” Thus, a display that is updated at 60 Hz has frames that are 16 msec. “Frames” are not limited to use with an active matrix backplane, however. The driving frames described herein can also be used to refer to a unit of time between updates of, e.g., a singular backplane. While it is possible to drive electrophoretic media with an analog voltage signal, such as produced by a power supply and a potentiometer, the use of a digital controller discretizes the waveform into blocks that are typically on the order of 10 ms, however shorter or longer frame widths are possible. For example, a frame can be 0.5 ms, or greater, such as 1 ms, 5 ms, 10 ms, 15 ms, 20 ms, 30 ms, or 50 ms. In most instances a frame is less than 100 ms, such 250 ms, 200 ms, 150 ms, or 100 ms. In most applications described herein, the frame is between 5 ms and 30 ms in width, for example 8 ms in width. Specialized drive controllers for electrophoretic displays are available from, e.g., Ultrachip and Rockchip, however programmable voltage drivers can also be used, such as available from Digi-Key and other electronics components suppliers.

In a conventional electrophoretic display using an active matrix backplane, each pixel electrode has associated therewith a capacitor electrode (storage capacitor) such that the pixel electrode and the capacitor electrode form a capacitor; see, for example, International Patent Publication WO 01/07961. In some embodiments, N-type semiconductor (e.g., amorphous silicon) may be used to from the transistors and the “select” and “non-select” voltages applied to the gate electrodes can be positive and negative, respectively.

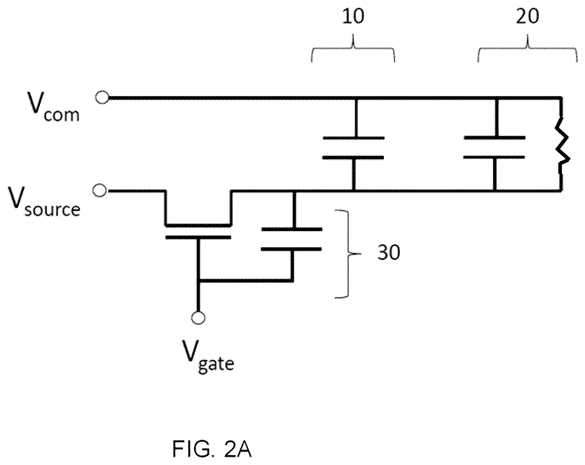

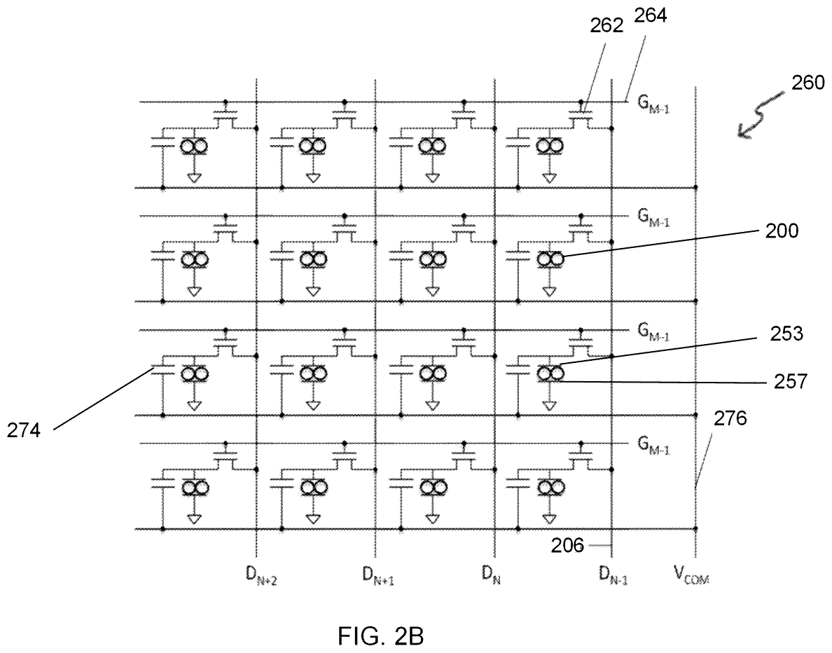

FIG. 2A of the accompanying drawings depicts an exemplary equivalent circuit of a single pixel of an electrophoretic display. As illustrated, the circuit includes a capacitor 10 formed between a pixel electrode and a capacitor electrode. The electrophoretic medium 20 is represented as a capacitor and a resistor in parallel. In some instances, direct or indirect coupling capacitance 30 between the gate electrode of the transistor associated with the pixel and the pixel electrode (usually referred to a as a “parasitic capacitance”) may create unwanted noise to the display. Usually, the parasitic capacitance 30 is much smaller than that of the storage capacitor 10, and when the pixel rows of a display is being selected or deselected, the parasitic capacitance 30 may result in a small negative offset voltage to the pixel electrode, also known as a “kickback voltage”, which is usually less than 2 volts. In some embodiments, to compensate for the unwanted “kickback voltage”, a common potential V_{com}, may be supplied to the top plane electrode and the capacitor electrode associated with each pixel, such that, when V_{com} is set to a value equal to the kickback voltage (V_{KB}), every voltage supplied to the display may be offset by the same amount, and no net DC-imbalance experienced.

In many embodiments, the TFT array forms an active matrix 260 for image driving, as shown in FIG. 2B. For example, each pixel electrode 253 (corresponding to 130 in FIGS. 1A and 1B) is coupled to a thin-film transistor 262 patterned into an array, and connected to gate (row) driver lines 264 and source (column) driver lines 206, running at right angles to the gate drive lines 264. Also, typically, the common (top) light-transparent electrode 257 (corresponding to 110 in FIGS. 1A and 1B) has the form of a single continuous electrode while the other electrode or electrode layer is patterned into a matrix of pixel electrodes 253, each of which defines one pixel of the display. Between the pixel electrode 253 and the common electrode 257, an electrophoretic medium 200 can be disposed. Any of the electrophoretic media described above may be used, and while FIG. 2B depicts the electrophoretic medium as contained in microcapsules, microcells, as shown in FIG. 1B, as also suitable. A source driver (not shown) is connected to the source driver lines 206 and provides source voltage to all TFTs 262 in a column that are to be addressed. A gate driver (not shown) is connected to the gate driver lines 264 to provide a bias voltage that will open (or close) the gates of each TFT 262 along the row. The gate scanning rate is typically ~60-150 Hz. When the TFTs 262 are n-type, taking the gate-source voltage positive allows the source voltage to be shorted to the drain. Taking the gate negative with respect to the source causes the drain source current to drop and the drain effectively floats. Because the scan driver acts in a sequential fashion, there is typically some measurable delay in update time between the top and bottom row electrodes. It is understood that the assignment of “row” and “column” electrodes is somewhat arbitrary and that a TFT array could be fabricated with the roles of the row and column electrodes interchanged. Each pixel of the active matrix 260 also includes a storage capacitor 274 as discussed above with respect to FIG. 2A. The storage capacitors 274 are typically coupled to V_{com} line 276. In some embodiments the common light-transparent electrode 257 is coupled to ground, as shown in FIG. 2B. In other embodiments, the common light-transparent electrode 257 is also coupled to V_{com} line 276 (not shown in FIG. 2B).

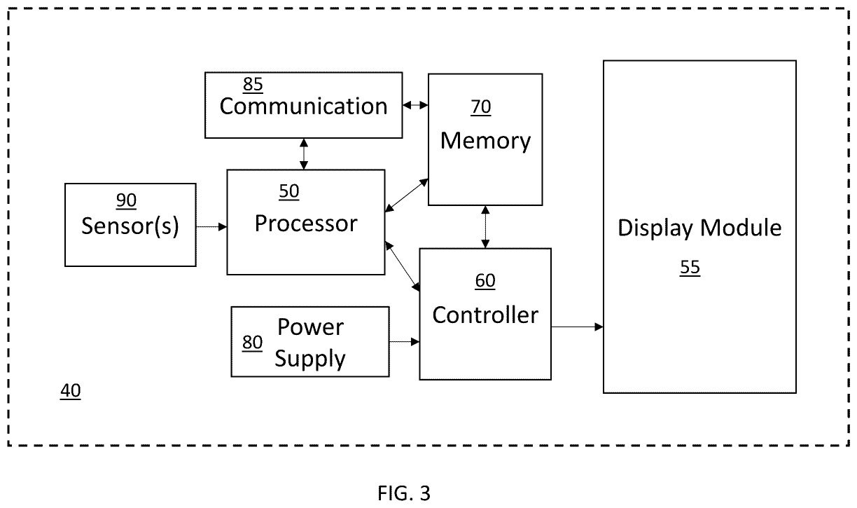

The active matrix 260 described with respect to FIG. 2B (i.e., including the electrophoretic medium 200 and the common light-transparent electrode 257) is typically covered by a protective sheet (e.g., integrated barrier) and sealed to create a display module 55, as shown in FIG. 3. Such a display module 55 becomes the focus of an electrophoretic display 40. The electrophoretic display 40 will typically include a processor 50, which is configured to coordinate the many functions relating to displaying content on the display module 55, and to transform “standard” images, such as sRGB images to a color regime that best duplicates the image on the display module 55. In some embodiments, the processor 50 performs the methods of the invention by determining which pixel electrodes should be updated during a partial update. Especially when dithering is being used for color production, the processor 50 can determine which areas of the dithered color are most at risk from blooming due to nearby pixel electrode updates. In other embodiments, some or all of the steps of the invention may be completed by the controller 60. As controller 60 architecture advances, more of the image processing can be embedded into the controller 60 such that an advanced controller can be incorporated into the same package as the display module 55 and pre-programmed with the tools needed to identify pixel electrodes that are at risk of blooming during a partial update. Advanced controllers for electrophoretic displays are available from ULTRACHIP and NEXTRONIX.

The processor 50 is typically a mobile processor chip made by manufacturers such Freescale or Qualcomm, although other manufacturers are known. The processor 50 is in frequent communication with the non-transitory memory 70, from which it pulls image files and/or look up tables to perform the color image transformations described below. The non-transitory memory 70 may also include gate driving instructions to the extent that a particular color transition may require a different gate driving pattern. The electrophoretic display 40 may have more than one non-transitory memory chip. The non-transitory memory 70 may be flash memory. Once the desired image has been converted for display on the display module 55, the specific image instructions are sent to a controller 60, which facilitates voltage sequences being sent to the respective thin film transistors (described above). Such voltages typically originate from one or more power supplies 80, which may include, e.g., a power management integrated chip (PMIC). The electrophoretic display 40 may additionally include communication 85, which may be, for example, WIFI protocols or BLUETOOTH, and allows the electrophoretic display 40 to receive images and instructions, which also may be stored in memory 70. The electrophoretic display 40 may additionally include one or more sensors 90, which may include a temperature sensor and/or a photo sensor, and such information can be fed to the processor 50 to allow the processor to select an optimum look-up-table when such look-up-tables are indexed for ambient temperature or incident illumination intensity or spectrum. In some instances, multiple components of the electrophoretic display 40 can be embedded in a singular integrated circuit. For example, a specialized integrated circuit may fulfill the functions of processor 50 and controller 60.

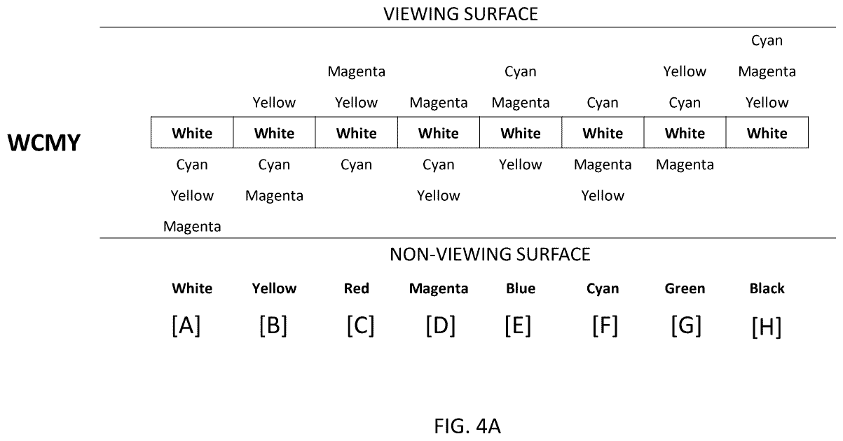

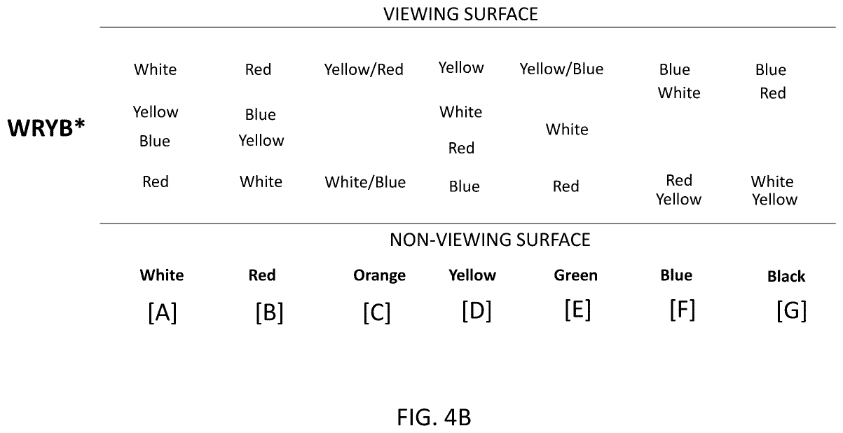

As discussed above, a color electrophoretic display may include a color filter array or an expanded particle system capable of producing all colors above each pixel electrode. As shown in FIG. 4A, in the instance of a four-particle system including subtractive cyan, yellow, and magenta particles paired with a reflective white particle, each of the eight principal colors (red, green, blue, cyan magenta, yellow, black and white) corresponds to a different arrangement of the four pigments. The three particles providing the three subtractive primary colors, e.g., for an Advanced Color electronic Paper (ACeP) display, may be substantially non-light-scattering (“SNLS”). The use of SNLS particles allows mixing of colors and provides for more color outcomes than can be achieved with the same number of scattering particles. These thresholds must be sufficiently separated relative to the voltage driving levels for avoidance of cross-talk between particles, and this separation necessitates the use of high addressing voltages for some colors. In addition, addressing the colored particle with the highest threshold also moves all the other colored particles, and these other particles must subsequently be switched to their desired positions at lower voltages.

The system of FIG. 4A, in principle, works similar to printing on bright white paper in that the viewer only sees those colored pigments that are on the viewing side of the white pigment (i.e., the only pigment that scatters light). In FIG. 4A, it is assumed that the viewing surface of the display is at the top (as illustrated), i.e., a user views the display from this direction, and light is incident from this direction. As already noted, in preferred embodiments only one of the four particles used in the electrophoretic medium of the present invention substantially scatters light, and in FIG. 4A this particle is assumed to be the white pigment. This light-scattering white particle forms a white reflector against which any particles above the white particles (as illustrated in FIG. 4A) are viewed. Light entering the viewing surface of the display passes through these particles, is reflected from the white particles, passes back through these particles and emerges from the display. Thus, the particles above the white particles may absorb various colors and the color appearing to the user is that resulting from the combination of particles above the white particles. Any particles disposed below (behind from the user's point of view) the white particles are masked by the white particles and do not affect the color displayed. Because the second, third and fourth particles are substantially non-light-scattering, their order or arrangement relative to each other is unimportant, but for reasons already stated, their order or arrangement with respect to the white (light-scattering) particles is critical.

More specifically, when the cyan, magenta and yellow particles lie below the white particles (Situation [A] in FIG. 4A), there are no particles above the white particles and the pixel simply displays a white color. When a single particle is above the white particles, the color of that single particle is displayed, yellow, magenta and cyan in Situations [B], [D] and [F] respectively in FIG. 4A. When two particles lie above the white particles, the color displayed is a combination of those of these two particles; in FIG. 4A, in Situation [C], magenta and yellow particles display a red color, in Situation [E], cyan and magenta particles display a blue color, and in Situation [G], yellow and cyan particles display a green color. Finally, when all three colored particles lie above the white particles (Situation [H] in FIG. 4A), all the incoming light is absorbed by the three subtractive primary colored particles and the pixel displays a black color. Because the order of the particles between the pixel electrode and viewer is critical, a pixel electrode that is not updated during a partial update can be disturbed by a neighboring pixel that is being updated. Furthermore, the resulting color shift may not be predictable because the highest charged particles, typically cyan, move the most due to inter-pixel coupling.

An alternative particle set using reflective color particles is shown in FIG. 4B. In the embodiment of FIG. 4B, the reflective particles are white, red, and yellow, and they are combined with a semi-transparent blue, however alternative color sets could be used provided that the combination of colors suitably spanned the useful color spectrum. In the system of FIG. 4B, for white, red, and yellow, the color viewed at the surface is due to direct reflection of the colored particles, for orange it is a mixture of red and yellow reflective pigments. For green, blue, and black at the viewing surface, the colors at the viewing surface are due to mixtures of the semi-transparent blue particle with reflective yellow, white, and red particles, respectively. Because a viewer is looking at light that is predominantly only interacting with one pigment surface, images produced with a system of FIG. 4B appear more saturated than the colors of FIG. 4A. However, the overall gamut of colors using a system of FIG. 4B is diminished as compared to those of FIG. 4A because it is difficult to achieve fine control of the amount of specific particles that are mixed together to create secondary colors (e.g., orange, green, violet). In applications such as digital signage, the saturation is often more important than the color gamut, and many users are satisfied with a set of seven or eight “standard” colors. It should also be realized with respect to FIG. 4B, that the reflective red and semi-transparent blue particles can switch roles, i.e., to make an electrophoretic display medium including reflective white, yellow, and blue particles and a semi-transparent red particle. Such a system yields a set of primary colors similar to FIG. 4B, but wherein red at the viewing surface results from a combination of semi-transparent red and white. Because the system of FIG. 4B includes mostly reflective particles, electrophoretic displays including this medium are less influenced by inter-pixel coupling. However, the methods of the invention can still be used with these systems.

Different combinations of light scattering and light absorbing particle sets are also possible. For example, one subtractive primary color could be rendered by a particle that scatters light, so that the display would comprise two types of light-scattering particle, one of which would be white and another colored. In this case, however, the position of the light-scattering colored particle with respect to the other colored particles overlying the white particle would be important. For example, in rendering the color black (when all three colored particles lie over the white particles) the scattering colored particle cannot lie over the non-scattering colored particles (otherwise they will be partially or completely hidden behind the scattering particle and the color rendered will be that of the scattering colored particle, not black). Of course, it would not be easy to render the color black if more than one type of colored particle scattered light without the presence of an absorptive black particle.

FIGS. 4A and 4B show idealized situations in which the colors are uncontaminated (i.e., the light-scattering white particles completely mask any particles lying behind the white particles in FIG. 4A, or the selected reflective particles shield all of the other particles that should not be visible in FIG. 4B). In practice, the masking by the white particles may be imperfect so that there may be some small absorption of light by a particle that ideally would be completely masked. Such contamination typically reduces both the lightness and the chroma of the color being rendered. In the instance of FIG. 4B, the presence of the light-absorbing particles often causes the overall image to look darker due to imperfect scattering of the reflective particles. This is particularly problematic for green hues because the human eye is very sensitive to different shades of green, whereas different shades of red are not as noticeable. In some embodiments, this can be corrected with the inclusion of additional particles with different steric or charge characteristics, e.g., a green scattering particle, however adding additional particles complicates the drive scheme and may require a wider range of driving voltages. Obviously, in the electrophoretic media described herein, such color contamination should be minimized to the point that the colors formed are commensurate with an industry standard for color rendition. A particularly favored standard is SNAP (the standard for newspaper advertising production), which specifies L*, a* and b* values for each of the eight primary colors referred to above.

Waveforms for driving four-particle electrophoretic media have been described previously. Waveforms for driving color electrophoretic displays having four particles are described in U.S. Pat. Nos. 9,921,451, 9,812,073, and 11,640,803, all of which are incorporated by reference herein. Most commercial electrophoretic displays use amorphous silicon based thin-film transistors (TFTs) in the construction of active matrix backplanes (e.g., 260) because of the wider availability of fabrication facilities and the costs of the various starting materials. Amorphous silicon thin-film transistors may become unstable when supplied gate voltages that would allow switching of voltages higher than about +/−15V. Accordingly, as described in previous patents/applications on such systems, improved performance is achieved by additionally changing the bias of the top light-transmissive electrode with respect to the bias on the backplane pixel electrodes, a technique known as top-plane switching. Thus, if a voltage of +30V (relative to the backplane) is needed, the top plane may be switched to −15V while the appropriate backplane pixel is switched to +15V. Methods for driving a four-particle electrophoretic system with top-plane switching are described in greater detail in, for example, U.S. Pat. No. 9,921,451.

In alternative embodiments, metal oxide semiconductors may be incorporated into thin film transistors for active matrix backplanes (e.g., 260), as described in U.S. Pat. No. 11,776,496, which is incorporated by reference in its entirety. One preferred metal oxide material for such applications is indium gallium zinc oxide (IGZO). IGZO-TFT has 20-50 times the electron mobility of amorphous silicon. By using IGZO TFTs in an active matrix backplane, it is possible to provide voltages of greater than 30V via a suitable display driver. Furthermore, a source driver capable of supplying at least five, and preferably seven levels provides a different driving paradigm for a four-particle electrophoretic display system. For example, the waveforms in a five-level drive scheme may be represented as V++, V+, 0, V−, and V−−, wherein V++ and V−− are at least 24V in magnitude. Additional voltage levels may be added, e.g., a seven-level drive scheme including V+++, V++, V+, 0, V−, V−−, and V−−−, wherein V+++ and V−−− are at least 24V in magnitude. As one example, the voltages in a seven-level drive scheme may be substantially +/−24V, +/−18V, +/−10V, and 0V. In some embodiments, the highest magnitude voltage levels may be 27V in magnitude or more, or 30V in magnitude or more.

Accordingly, in an embodiment, there will be two positive voltages, two negative voltages, and zero volts. In another embodiment, there will be three positive voltages, three negative voltages, and zero volts. In yet another embodiment, there will be four positive voltages, four negative voltages, and zero volts. These levels may be chosen within the range of about-27V to +27V, without the limitations imposed by top plane switching as described above.

Even when an electro-optic display includes a medium made up of only black and white charged particles, it is nonetheless still highly desirable to be able to present grayscale images on an electro-optic display. This grayscale may be achieved either by driving a pixel of the display to a gray state intermediate of the display's two extreme states (e.g., black and white). However, if the medium is not capable of achieving the desired number of intermediate states, or if the display is being driven by drivers that are not capable of providing voltages necessary to drive the charged ink particles to the desired number of intermediate states, other techniques such as half-toning or spatial dithering must be used to achieve the desired number of states.

When a dithered image is viewed at a sufficient distance, the individual colored pixels are merged by the human visual system into perceived uniform colors. Because of the trade-off between color depth and spatial resolution, dithered images when viewed closely have a characteristic graininess as compared to images in which the color palette available at each pixel location has the same depth as that required to render images on the display as a whole. However, dithering reduces the presence of color-banding which is often more objectionable than graininess, especially when viewed at a distance.

There are various means known in the art to achieve a grayscale display using dithering techniques. Spatial modulation creates grayscale by dithering, a process by which a certain proportion of pixels within a localized area of the array of pixels (or cells) that comprise the display are set to a first color and the remainder of pixels in the localized area are set to a second color, giving the visual effect to one viewing the display of a shade in between the first and second colors. For example, to achieve a shade of gray, every other pixel in the localized area may be set to white and the remainder set to black. To achieve a lighter shade of gray, a higher proportion of pixels in the localized area may be set to white. To achieve a darker shade of gray, a higher proportion of pixels in the localized area may be set to black.

These half-toning and dithering techniques have been used for many decades in the printing industry to represent gray tones by covering a varying proportion of each pixel of white paper with black ink. Further, as indicated above, dithering can also be used to increase the quantity of colors an electrophoretic display is capable of presenting. Other shades and colors may be displayed or approximated by combining pixels set to two or more different colors. For example, similar half-toning schemes can be used with CMY or CMYK color printing systems, with the color channels being varied independently of each other.

Turning to display update time, when update time is not critical, such as for eReader applications where there can be several minutes between each page turn requiring an image update, a display may operate using a drive scheme such as “Global Complete” (“GC mode”) where each pixel has the ability to fully transition from a first optical state to a second optical state during each image update. Of course, as described in, e.g., U.S. Pat. No. 10,657,869, such updates can be time consuming (e.g., 1 second or more), especially when DC balancing and remnant voltage management are required to achieve the highest quality colors. For this reason, displays typically use faster update schemes for displaying animated or video content, where a very quick update is desired and the user is willing to sacrifice fidelity in exchange for a faster update experience. Such quicker update schemes are typically known as “Direct Update” (“DU mode”) and typically involve simply driving the electrophoretic medium to the black and white extents. See, e.g., U.S. Pat. No. 9,672,766. For higher end products, such as color eReaders/tablets, there may be multiple kinds of each mode, depending upon the content that is being displayed. Additional modes, such as animation (a.k.a. “A2 mode”) may also be included, and the display controller may be programmed to automatically switch between modes depending upon the content being displayed. Update times for the faster update schemes are typically on the order of 100 ms.

As discussed above, half-toning and dithering techniques are typically employed to give the viewer the perception of uniform grayscale or intermediate colors despite the image being presented using a limited palette of available colors. However, such techniques can cause unpleasant patterns and textures to appear in images. Accordingly, algorithms for assigning particular colors to particular pixels have been developed in order to avoid or reduce these undesirable artifacts.

Such algorithms may involve error diffusion, a technique in which error resulting from the difference between the color required at a certain pixel and the closest color in the per-pixel palette (i.e., the quantization residual or error) is distributed to neighboring pixels that have not yet been processed. The assignment of the closest color is done such that the difference from target value and accumulated error from nearby pixels is minimized. This method often achieves the best visual resolution because it adapts the window size over which the averaging is performed. The improved resolution is achieved because the distribution of error adjusts to local properties. The distribution of error is done using a set of spatial weights known as a kernel, such as the Floyd Steinberg error diffusion kernel shown above. In general, the kernel size for error diffusion can be larger than one sample. For example, the kernel can be a matrix of values. Any fraction (or even multiples) of the error can be diffused into each pixel in the kernel. European Patent No. 0677950 describes such techniques in detail, while U.S. Pat. No. 5,880,857 describes a metric for comparison of dithering techniques.

Accordingly, for animation and video content, the waveforms used from the faster drive schemes that are short enough in duration to allow for smooth animation can typically only drive pixels to extreme black or white states, or limited intermediate states, thus necessitating some form of half-toning or dithering with an algorithm such as error diffusion to prevent or reduce image artifacts. However, in practice, an error diffusion algorithm changes the value of certain pixels in an image as it distributes the quantization error (the difference between the original pixel value and its quantized value) to neighboring pixels. The algorithm effectively “spreads out” the error across the image to create a more visually smooth result, despite using a limited color palette. This means that even during a transition between two closely correlated images such as consecutive images in a video or animation, the value of the dithered pixels may change from one extreme state to the other extreme state.

Based on statistical noise in video and animation content, the error diffusion algorithm can create random toggling patterns in the pixels due to statistic image differences. Toggling in this context refers to the transition of the value of a pixel from one quantization state to the other. For example, a pixel with a quantization value of black or 0 toggling to a value of 1 or white. The toggling causes the pixels to undergo the equivalent of a clearing cycle and hence reduces the ghosting. Error diffusion dithering can therefore have better ghosting performance than standard mask-based dithering in many cases.

However, error diffusion applied per image still does not guarantee ghost free performance in all scenarios. Based on the sequence of images, the time to clear ghosting can vary greatly since different scenarios have different toggling patterns. For example, pixels in areas of images with content that primarily remains static have lower toggling rates in those static portions and therefore do not clear ghosting in a short enough time to be undetected or unnoticeable by the human eye. Even sequences of images having moving objects are not guaranteed to have good ghosting performance in all scenarios. For example, ghosting can be most pronounced when a sequence of images includes an object that moves quickly through a region of pixels, and that region of pixels subsequently does not get updated much or at all after the object passes through it.

Further, as discussed above, error diffusion techniques can produce a residual sharp contour pattern that can vary from image to image and can have the appearance of noise on video. As indicated above, discounting some of the error determined by the error diffusion kernel can suppress this noise, at the expense of reduced resolution due to information loss.

In some instances, the results of error diffusion can be improved by adding noise to the images. The noise can randomize the dithering pattern and hence potentially increase the frequency of pixel toggling. However, the addition of uncorrelated noise can be visually distracting, and can also potentially increase the contour patterns created by the error diffusion process. Adding uncorrelated noise does not allow independent control of which pixels toggle. As a result, toggling can occur more frequently in areas of an image having pixels that do not necessarily need to be toggled, thereby causing more visual distracting artifacts instead of clearing the ghosting.

The results of an error diffusion method improve further if the noise pattern can be configured to be closely correlated to the currently-processed image, and by also diffusing a part of the error in time instead of just in space. For example, a portion of the error in a pixel in the current image can be diffused into the same pixel (or its neighbors) in the next image. This temporal diffusion of error enables the static areas of pixels to accumulate deviations/errors that cause them to toggle due to the diffusion process. This can be smoother and less distracting in static areas and can also reduce the contour lines since the temporal diffusion of part of the error from one image into the next effectively acts as a discount on the error diffusion kernel in the spatial sense.

Using this technique has effects that go beyond just the pixel (or its neighbors) in the next image to which the error is diffused. There are also effects related to the toggling dynamics of each pixel on its adjacent pixels. For example, the value of a toggled pixel influences pixels adjacent to it, which may then cause the adjacent pixels to toggle in the subsequent images in a cascading manner. Note that the net spatial error over an average region will be near 0, since error from one pixel will be compensated by others. Accordingly, this technique can provide other benefits such as preserving region wise fidelity.

However, while it can be beneficial to induce toggling amongst adjacent pixels, such toggling can also have the drawback of blurring the image. For example, when the value of a pixel is not correlated between consecutive images, the current image content (or its inverse) can be visually embedded into subsequent images since the temporal error pattern is correlated to the value of the pixel in the current image. In extreme cases, this can create algorithmic ghosting in areas where the subsequent images are not correlated (e.g., areas in an image in which there is movement of an object). To mitigate these effects, the temporal diffusion weights can be minimized. However, this has the tradeoff of reducing the pixel clearing efficiency, and also reducing the ability to mitigate the generation of unwanted contour line artifacts.

The subject matter disclosed herein overcomes the deficiencies described above, and includes an inventive method that uses fully DC balanced waveforms having very short update times. The method includes a novel error diffusion technique that enables video to be presented on an electrophoretic display with smooth transitions between images while also minimizing the amount of ghosting. The novel error diffusion algorithm diffuses error both in spatial and temporal dimensions, optimally forces pixels to toggle between rail or quantization states, and automatically removes ghosting, while also producing visually pleasant image transitions. Through the use of an adaptive 3D kernel, the algorithmic ghosting of fast-moving objects created by conventional temporal diffusion techniques can be reduced or eliminated by the methods disclosed herein.

The goal of the algorithm disclosed herein is to diffuse error as much as possible to cause maximum toggling and maximum artifact suppression, while preserving average image fidelity over time. Accordingly, the algorithm seeks to diffuse more when diffusion is not going to cause artifacts, and not to diffuse when doing so is likely to cause artifacts. A simple naïve assessment of how similar the current image is to the next image can be obtained by cross-correlating the value of each pixel (or a patch of pixels) in the current image with the value of the same pixel (or patch of pixels, or a larger region of pixels including the same pixel) in the next image. The resulting cross-correlation coefficient (i.e., the result of the assessment of the similarity of the value of the same pixel in two images) is expected to be largest when the value of the pixel is the most similar between the two images. However, while this technique can give an indication in a naïve sense of how similar the values of pixels in the current and next images are, the result can be prone to inaccuracy based on the values of the pixels being cross-correlated.

For example, based on the naïve assessment described above, there are generally three outcomes to an individual pixel cross-correlation operation for a diffusion scheme using two quantization states (e.g., black or 0, and white or 1). First, the values of the pixels are maximally correlated in the case where the value of a pixel is at or near 1 in the current image and also at or near 1 in the next image. Second, the values of the pixels are anti-correlated in the case where the value of a pixel is at or near 1 in the current image and the same pixel is at or near 0 in the next image (or conversely, when the value of a pixel is at or near 0 in the current image and the same pixel is at or near 1 in the next image). However, in the third case when the value of a pixel is at or near 0 in the current image and also at or near 0 in the next image, cross-correlation results in a value at or approaching 0, falsely indicating low or no correlation between the values of the pixels. Accordingly, feeding the cross-correlation coefficients output from the naïve assessment into the diffusion algorithm results in diffusing appropriately for some pixels (e.g., both pixels near 1, pixels near different quantization values), but fails to diffuse appropriately for others (e.g., both pixels near 0).

One way to improve the results of the cross-correlation is to calculate and apply a Quantization Alignment Offset (“QAO”) to the values of the pixels in the current and subsequent images prior to cross-correlation. The QAO is a value that can be used to alter the pixel data in a way that improves the results of the cross-correlation operation, especially for the third case discussed above (i.e., when the value of a pixel is at or near 0 in the current image and also at or near 0 in the next image). The QAO is calculated based on the mean of the pixel alignment offset values calculated for each pixel in the current image.

To determine the pixel alignment offset of each pixel, a normalized damping factor set, w0 and w1, is first chosen with values such that w0+w1=1. The normalized damping factor set can be used to influence which pixels, and on a larger scale, which regions of pixels, are expected to toggle more and which are expected to toggle less based on the proximity of the values of the pixels to a particular quantization state. The values of the w0 and w1 are typically constant throughout the process.

The normalized damping factors or weights, w0 and w1, correspond to quantization states q0 and q1, respectively. To help facilitate an understanding of these concepts, the example provided herein relates to an electrophoretic display system using only two quantization states, q0 and q1, corresponding to the black and white rail states, respectively. The black and white rail states are also referred to as the “optical rails” or extreme optical states.

The procedure to obtain the pixel alignment offset is as follows. For each pixel in an image, the target value, q′, of the pixel is compared to the quantization states, q0 and q1, to determine which quantization states are nearest to q′. (In this context, q′ is the target value of the pixel without incorporating any effects of the error diffusion process temporally or spatially.) In this simplified example with only two possible values for the quantization states (e.g., black or white), the values of q0 and q1 are 0 and 1, respectively. However, the method described herein is also applicable to electrophoretic display systems having more than two quantization states. For example, in a system having four possible levels of quantization, q0 and q1 could correspond to levels 0 and 1, 1 and 2, 2 and 3, or 3 and 4, respectively, depending on the value of q′.

The pixel alignment offset value of a pixel is the weighted mean of the nearest quantization states to the pixel's target value q′ using the normalized toggle damping factor set. In particular, the pixel alignment offset can be calculated using the following equation:

$$\frac{{w}_{0} \cdot {q}_{0} + {w}_{1} \cdot {q}_{1}}{{w}_{0} + {w}_{1}}$$

The pixel alignment offset is determined for every pixel in the current image. The QAO for the current image is the mean of the pixel alignment offset values for every pixel in the current image.

As indicated above, the values of w0 and w1 can be used to influence which pixels the error diffusion algorithm toggles from one quantization state to another based on the proximity of the values of the pixels to a particular quantization state. For example, setting both w0 and w1 to 0.5 has the effect of causing the error diffusion algorithm to toggle pixels close to either rail state with the same frequency. In other words, if w0 and w1 are the same (i.e., 0.5), the error diffusion algorithm diffuses error to pixels at the rate whether the pixel is near q0 or near q1.

Alternatively, setting w0 to a value greater than w1 acts as a dampening factor for the toggling rate of pixels near quantization state q0. Accordingly, when w0>w1, the error diffusion algorithm diffuses error at a rate such that pixels near quantization state q0 tend to toggle less frequently than pixels near quantization state 1. The converse is also true when w1 is chosen to be greater than w0. The term “w₀+w₁” in the denominator of the pixel alignment offset equation ensures that the result is normalized to fall within the range of 0 and 1 when w0 is not equal to w1.

This feature is described in more detail below in the context of the error diffusion algorithm. For the present example having two quantization states, q0=0 and q1=1, setting w0=w1=0.5, the pixel alignment offset for every pixel in the current image is calculated to be 0.5:

$$\frac{0.5 \cdot 0 + 0.5 \cdot 1}{0.5 + 0.5} = 0.5$$

The next step is to determine the QAO for the current image by calculating the mean of the pixel alignment offset values for every pixel in the current image. Accordingly, the QAO of the current image for this example is 0.5.

Once the QAO is determined, the value of the QAO is subtracted from the value of every pixel in the current image and the temporal diffusion images. This process effectively centers the image data for the next step, and addresses the cross-correlation result issue discussed above with the naïve assessment. For example, reexamining the three outcomes of the individual pixel cross-correlation operation for a diffusion scheme using two quantization states (e.g., black or 0, and white or 1) after the QAO has been subtracted from the value: For the first case where the original value of the pixel is at or near 1 in the current image and also at or near 1 in the next image, subtracting the QAO (e.g., 0.5) from both pixels results in a value at or near 0.5 for each pixel. Accordingly, cross-correlation of the adjusted values of the pixels results in a value at or near 0.25, which is still maximally correlated in this case.

For the second case where the value of the pixel is at or near 1 in the current image and the same pixel is at or near 0 in the next image (or conversely, when the value of the pixel is at or near 0 in the current image and the same pixel is at or near 1 in the next image), subtracting the QAO from both pixels results in a value at or near 0.5 for one pixel and at or near −0.5 for the other pixel. Accordingly, cross-correlation of the adjusted values of the pixels results in a value at or near −0.25, which is uncorrelated in this case.

Finally, in the third case when the value of the pixel is at or near 0 in the current image and also at or near 0 in the next image, subtracting the QAO from both pixels results in a value at or near −0.5 for both pixels. Accordingly, cross-correlation of the adjusted values of the pixels results in a value at or near 0.25, which is now maximally correlated for this case, whereas before the cross-correlation falsely indicated low or no correlation between the values of the pixels.

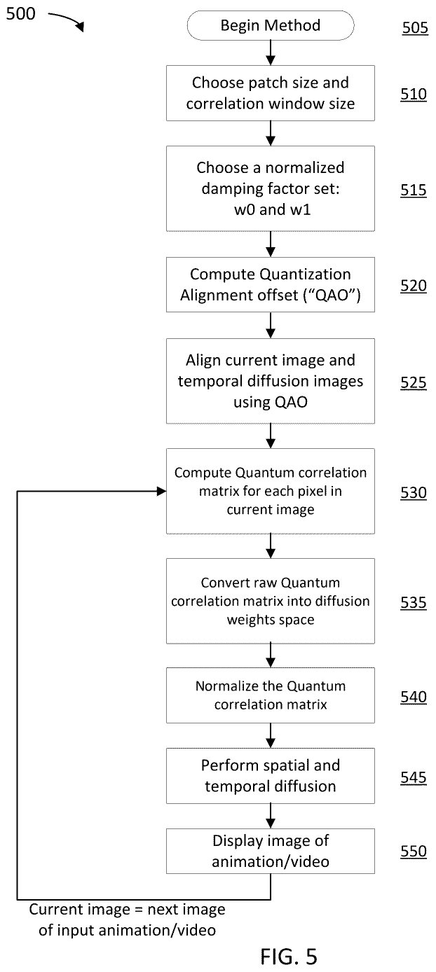

FIG. 5 is a flow diagram detailing the steps of a method 500 for adaptive temporal error diffusion dithering for presenting animation on electrophoretic displays. The method 500 begins at step 505 with a request to process and/or display a sequence of images on an electrophoretic display. There are numerous events that can trigger such a request. For example, the method 500 can begin with a request to process or render video or animation content for display on an electrophoretic display. As another example, a user of the electrophoretic display device can select a link to video or animation content to be displayed on the electrophoretic display.

Step 510 includes choosing a size for a patch of pixel values, and choosing a size for a correlation window of pixel values. For example, instead of performing the temporal kernel computation on a per pixel basis as in the example described above, it can be done on a per patch level and with strides (with or without overlaps).

As one example, consider a pixel in current image and a patch R_c of pixels surrounding and including the pixel. For example, a 9×9 patch of pixels can be chosen as the size for the patch of pixels in the current image. Further, consider a pixel in the subsequent or next image (preferably the same pixel) and a window R_t (larger than R_c) of pixels surrounding and including that pixel. For example, a 15×15 window of pixels can be chosen as the size for the correlation window of pixel values in the next image. Assuming a stride size of 1, using a patch size of 9×9 and a correlation window size of 15×15 results in a 7×7 matrix of values after cross-correlation.

The sizes for the patch and correlation window provided above are exemplary, not exhaustive. For example, the sizes for the patch and correlation window can be chosen depending on parameters such as the electrophoretic display panel's typical viewing distance and the degree to which optimize for it. In some embodiments, the sizes for the patch and correlation window can be chosen depending on parameters such as the resolution of the electrophoretic display and/or the animation/video content to be displayed.

Performing the temporal kernel computation in a patchwise manner has multiple benefits. The computational complexity of performing the temporal kernel computation is reduced. Further, isolated pixel artifacts get suppressed as performing the computations on a patch level soft de-noises the data and takes into account the effect of spatial error diffusion from neighbors affecting the current pixel's diffusion. Finally, performing the temporal kernel computation in a patchwise manner actually preserves fidelity per image better than other techniques because the resulting net temporal error will be near 0.

Step 515 includes choosing a normalized damping factor set. The normalized damping factor set, w0 and w1, is chosen as described in the example above with values such that w0+w1=1. Further, the normalized damping factors or weights, w0 and w1, correspond to quantization states q0 and q1, respectively, where q0 is less than q1.

Step 520 includes computing a quantization alignment offset or QAO. In order to compute the QAO, the pixel alignment offset is first determined for every pixel in the current image as described in the example above. The QAO for the current image is then the mean of the pixel alignment offset values for every pixel in the current image.

Step 525 includes aligning the current image of an animation with the quantization alignment offset. Step 525 also includes aligning one or more diffusion images of an animation with the quantization alignment offset. For example, the QAO is subtracted from every pixel in the current image and from every pixel in the temporal diffusion images. The temporal diffusion images are the images subsequent to the current image in the animation or video. In some embodiments, the QAO is subtracted from every pixel in the current image and from every pixel in a predetermined number of temporal diffusion images. For example, the temporal error diffusion process can be configured to diffuse error from the current image into just the next image in the animation or video. In this case, the QAO is subtracted from just one diffusion image. In some embodiments, the temporal error diffusion process can be configured to diffuse error from the current image into two or more subsequent images. In this case, the QAO is subtracted from a number of diffusion images that matches the number of images into which the error from the current image will be diffused. This process step centers the input data for the next step, and resolves the cross-correlation issue discussed in the example above when two pixels have a value at or near 0.

Step 530 includes computing a quantum correlation matrix for the pixels in the current image. The quantum correlation matrix is analogous to a score that determines the ratio of temporal diffusion that can be applied from a pixel in the current image to pixels in the diffusion image(s). In general, the size of the quantum correlation matrix is determined by (number_of_diffusion_images×number_of_diffusion_horizontal_pixels×number_of_diffusion_vertical_pixel) where number_of_diffusion_images can be one (e.g., current image diffusing error only into the next image), two (e.g., current image diffusing error into the next two subsequent images), or more.

To compute the quantum correlation matrix, the correlation kernel is set to be a patch of pixel values in the current image having the size chosen above (e.g., patch R_c). Sliding correlation is performed with a correlation window of pixel values in the next image having the size chosen above (e.g., window R_t). (The values of the pixels in the patch and the window of pixels used for the sliding correlation are the values that had the QAO subtracted from them in step 525.) The sliding correlation operation can be a cross-correlation operation in which the patch of pixel values serving as the correlation kernel (e.g., patch R_c) is moved over the larger correlation window (e.g., R_t) while computing the sum of products of overlapping values of R_c and R_t each time the kernel is shifted by a number of pixels corresponding to the stride size.

Assuming a stride size of 1, using a patch size of 9×9 for path R_c and a correlation window size of 15×15 for correlation window R_t results in a 7×7 quantum correlation matrix after sliding correlation is completed. The value of each element in the quantum correlation matrix provides information about the extent of temporal diffusion optimal in that direction. For example, instead of being single value based on the value of one pixel location, the temporal diffusion kernel is a matrix with high values where there has been the most movement, and low values where the values of pixels have remained static from one image to another. The information in the matrix can be used to optimize the pace of diffusion to enable regions near the rails as well as regions closer to the midpoint to toggle without causing artifacts.

Accordingly, the sliding correlation operation that produces the quantum correlation matrix enables a form of object tracking for improving visual fidelity. For example, the values of the quantum correlation matrix can be used to visually track where an object has moved from image to image in order to know where to diffuse error to get the best visual effect without creating artifacts.

The quantum correlation matrix also enables a form of optical flow measurement different from a conventional naïve optical flow measurement, which is typically used in a limited manner to figure out if an object is present in a location or not. The optical flow measurement enabled by the quantum correlation matrix is not used to discern whether an object is present or not. Instead, the values of the quantum correlation matrix indicate whether or not to diffuse error to a particular pixel or region of pixels regardless of what an object is and the extent to which it has changed position from image to image. The described method therefore tackles the more robust problem of knowing how to diffuse the error spatially and encode all of the image information without loss while minimizing the occurrence of visual artifacts. This results in better temporal accuracy per pixel and more efficient clearing of pixels that would otherwise cause artifacts.

For patches of pixels near the corners of an image, each pixel is processed as individual pixel correlations instead of patch wise. The correlation weights are also modified to set the value of any out of bound pixel to 0. Patches near the boundaries, but not at corners, have patching and stride applied across the relevant dimension alone. When the remaining size is not a multiple of the required stride size, some additional regions are introduced that perform a hybrid between striding and non-striding.

In some embodiments, additional operations can optionally be performed on the quantum correlation matrix. In some embodiments, a nonlinear transform can be applied to the kernel and correlation images before correlating to fine tune toggling patterns. In some embodiments, correlation over rotated versions of the kernels can also be used to detect rotations and enhance the diffusion further.

Step 535 includes converting the quantum correlation matrix for each pixel into a plurality of temporal diffusion weights. This step converts the raw values of the quantum correlation matrix into the temporal diffusion weights space. There are three main stages in this step: linearity correction, matrix neighborhood pooling, and patch neighborhood pooling.

Linearity correction is used to linearize the values of the quantum correlation matrix to be applicable as temporal diffusion weights. The raw values obtained for the quantum correlation matrix are in a nonlinear space as they carry numbers that follow a square law scale, such that changes in the output quantum correlation matrix are not directly proportional to the changes in the input image information. For optimal performance, these values can be transformed into a linearized space for temporal diffusion by using another non-linear transform mapping.

A wide range of possibilities exist for linearizing these values. For the purpose of maximizing toggling, it is most effective to weight the rail-correlated states more than uncorrelated states, and not to diffuse for pixels in uncorrelated states. The non-linear operation applied is (max(score, threshold)\hat{ }(gamma)) where a typical value is threshold=0 and gamma=1.

This step also computes a conditional that is used in the following steps. The elements that encountered clamping will be handled different from the elements that did not.

The raw values computed for the quantum correlation matrix may be noisy and can result in significantly different diffusion weights being applied to neighboring pixels. This can lead to unstable performance and sensitivity to noise in the video or animation. Accordingly, the present method uses matrix neighborhood pooling to de-noise these values by taking into account the interaction of neighboring pixels with the current pixel.

One way to perform matrix neighborhood pooling is to analyze a pool of pixel values over a specific neighborhood region. As one example, matrix neighborhood pooling can be performed over a four pixel neighborhood of the current pixel. A max pooling operation can be used whereby the value of the current pixel is compared to four neighboring pixels (typically the pixel above, below, to the left, and to the right of the current pixel, also referred to as the “cardinal neighbors” of the current pixel). If the value of the current pixel is greater than 0, the current pixel is set to the maximum value of the neighboring pixels. Alternately, if the value of the current pixel is less than 0, the value of the current pixel is set or “clamped” to 0, ultimately meaning that the spatial kernel will not cause error to be diffused to the current pixel. Accordingly, the matrix neighborhood pooling maximizes toggling on regions where pixel values are correlated, while blocking uncorrelated pixels from receiving error. Max pooling is a nonlinear operation because it selects the maximum value within a region for pixels having a value greater than 0 while clamping other pixels to 0. This is a non-linear transformation of the input values, unlike linear operations that simply scale or add values.

In some embodiments, the method includes optional steps applicable to certain types of electrophoretic displays. For example, for electrophoretic displays that include a color filter array, temporally diffusing error from a pixel corresponding to one color of the color filter array to a pixel corresponding to a different color can cause artifacts. Such electrophoretic displays can use sparse quantum correlation matrix sampling whereby after the above correlation and non-linear matrix neighborhood pooling operations are performed, the diffusion space is constrained such that diffusion only occurs between the sparse set of pixels that correspond to the same in the array. In other words, error from a pixel corresponding to one color channel is only diffused to other pixels corresponding to the same color channel within the array. For this operation, the correlation and non-linear matrix neighborhood pooling operations are performed on the whole image set as above. The constraint on diffusion is only on the final diffusion weights that are to be applied to each pixel of a particular color channel.

Patch neighborhood pooling can be used to remove blocking artifacts caused by the patch wise operations of the previous steps. For a given patch of pixel values, for each element, the element values over a neighborhood are considered and pooled to smooth out edge artifacts per patch and also to optimize for interaction of spatial diffusion of pixels between different neighboring regions. Patch neighborhood pooling is similar to matrix neighborhood pooling, except that patch neighborhood pooling operates between patches of pixels. In some embodiments, patch neighborhood pooling is performed over patches of pixels that have some overlap with the current patch of pixels. The pixels that encountered clamping will be fixed to their clamped values as before.

Step 540 includes normalizing the quantum correlation matrix. First, based on values of the spatial kernel, a maximum temporal kernel value (alpha) is chosen to ensure optimal mapping to a value corresponding to the temporal resolution of the human eye. This step normalizes the temporal kernel matrix obtained per patch after the preceding steps into the diffusion kernel space. In other words, this step makes sure the values of the temporal kernel matrix are in an appropriate ratio to those of the spatial kernel.

There are primarily three steps for this operation. The first step includes determining the maximum available quantum correlation score on the matrix. The next step is calculating the sum of the quantum correlation scores of the matrix. The last step includes normalizing the quantum correlation matrix such that the new sum is equal to: (max_quantum_correlation_score/max_possible_score)*alpha. The normalization process at step 540 ensures that the diffused errors are invariant to translational dynamics of the current and next images. In some embodiments, step 535 and step 540 are considered a combined step and the operations corresponding to both steps are carried out contemporaneously.

Step 545 includes performing spatial and temporal error diffusion. As discussed above, spatial error diffusion is known in the art. In some embodiments, spatial error diffusion is carried out according to a Floyd-Steinberg dithering technique. Spatial error diffusion is carried out according to the example below.

A pixel's quantization target q(0) can be between quantization states q0 and q1, where q0<q1. For the sake of explanation, q(0) is closer to q1 than q0. If error diffusion is applied to the pixel, it will be assigned the value of q1 and the error accumulated will be (q(0)−q1). If some fraction “x” of this error is diffused to the same pixel having the same quantization target q(0) in the next image, then the error diffused is x(q(0)−q1), and hence the target for that pixel in the next image will be q(0)+x(q(0)−q1).

A few properties of this new state can be observed: The new state is further away from q1. For a fixed q(0), a larger x causes the new state to be further away from q1. This new state can be denoted as q(1) and the same rule can be applied.

In the second iteration, the state will be q(2)=q(0)+x(q(1)−q1) if the quantization target remains constant at q(0). The process can continue until q(n) is closer to q0, at which time the pixel will be assigned the value of q0, thereby causing the pixel to toggle its state.

Once this has happened the error for that pixel is now q(n)−q0. If x is chosen such that this q(n) does not overshoot and go below q0, the error in this iteration is now going to send the pixel's value in the opposite direction. Hence, for the next iteration, the value is set according to:

$$q ( n + 1 ) = {q}_{0} + x ( q ( n ) - {q}_{0} )$$

For this iteration, the result is greater than q(0) and the pixel is therefore assigned quantization state q1. The process repeats again, taking an equal or longer time than the first time through the spatial diffusion process to toggle the pixel.

Stability is not guaranteed if x is very large as it would cause significant oscillations. Accordingly, a scalar constant “k” can be applied to all values of x to keep the resulting pixel vales within a range that does not cause instability.

It is noted that using the spatial error diffusion process described herein, even a target state q(0) that remains unchanged between subsequent images is eventually assigned enough error to cause its state to toggle. The temporal diffusion can therefore cause pixels in regions that have an otherwise constant value to accumulate enough error to toggle. This has the benefit of clearing any ghosting that may occur due to, for example, an object moving quickly through an area of pixels, and then subsequently that area remaining static. Further, although there is some error locally at each pixel, over a region the average error is 0. Accordingly, for a region/patchwise basis, the average temporal diffusion error is 0, and there is no loss of image fidelity.

Step 550 includes displaying the current image of the animation or video content. For example, based on the values of the input image that have been modified according to the spatial and temporal error diffusion processes, a dithered version of the current image is displayed on the electrophoretic display.

After step 550, the next image in the animation or video becomes the current image, and the process returns to step 530 where a quantum correlation matrix is computed for each pixel in the new current image.

Having thus described several aspects and embodiments of the technology of this application, it is to be appreciated that various alterations, modifications, and improvements will readily occur to those of ordinary skill in the art. Such alterations, modifications, and improvements are intended to be within the spirit and scope of the technology described in the application. For example, those of ordinary skill in the art will readily envision a variety of other means and/or structures for performing the function and/or obtaining the results and/or one or more of the advantages described herein, and each of such variations and/or modifications is deemed to be within the scope of the embodiments described herein. Those skilled in the art will recognize, or be able to ascertain using no more than routine experimentation, many equivalents to the specific embodiments described herein. It is, therefore, to be understood that the foregoing embodiments are presented by way of example only and that, within the scope of the appended claims and equivalents thereto, inventive embodiments may be practiced otherwise than as specifically described. In addition, any combination of two or more features, systems, articles, materials, kits, and/or methods described herein, if such features, systems, articles, materials, kits, and/or methods are not mutually inconsistent, is included within the scope of the present disclosure.

1. A method for driving an electro-optic display having a plurality of display pixels, the method comprising:
choosing a size for a patch of pixel values;
choosing a size for a correlation window of pixel values;
choosing a normalized damping factor set;
computing a quantization alignment offset;
aligning a current image of an animation with the quantization alignment offset;
aligning a one or more diffusion images of an animation with the quantization alignment offset;
computing a quantum correlation matrix for the pixels in the current image;
converting the quantum correlation matrix for the pixels in the current image into a plurality of temporal diffusion weights;
normalizing the quantum correlation matrix;
performing spatial and temporal diffusion on the current image; and
displaying an image of the animation based on the diffused current image.

2. The method of claim 1 wherein aligning the current image using the quantization alignment offset comprises subtracting the QAO from the value of each pixel in the current image.

3. The method of claim 1 wherein aligning the one or more diffusion images of an animation using the quantization alignment offset comprises subtracting the quantization alignment offset from the value of each pixel in the one or more diffusion images.

4. The method of claim 1 wherein computing the quantum correlation matrix for each pixel in the current image comprises cross-correlating the patch of pixel values with the correlation window of pixel values.

5. The method of claim 1 wherein computing the quantization alignment offset comprises:
computing a pixel alignment offset for each pixel in the current image; and
determining the mean of the pixel alignment offset for each pixel in the current image.

6. The method of claim 5 wherein computing the pixel alignment offset comprises:
computing a first sum comprising:
(i) the product of a first quantization state value and a first factor of the normalized damping factor set, and
(ii) the product of a second quantization state value and a second factor of the normalized damping factor set; and
dividing the first sum by the sum of the first and second factors of the normalized damping factor set.

7. The method of claim 1 wherein the size of the patch of pixel values is smaller than the size of the correlation window of pixel values.

8. The method of claim 1 wherein the normalized damping factor set includes a first factor corresponding to a first quantization state value, and a second factor corresponding to a second quantization state value.

9. The method of claim 8 wherein the first factor is less than the second factor.

10. The method of claim 8 wherein the first quantization state value is less than the second quantization state value.

11. An electro-optic display comprising:
an electrophoretic medium comprising charged pigment particles;
a plurality of display pixels for driving the charged pigment particles between optical states, the plurality of display pixels arranged in a matrix comprising a two-dimensional array of rows and columns of display pixels; and
a controller operatively coupled to the plurality of display pixels,
wherein the controller is configured to:
choose a size for a patch of pixel values;
choose a size for a correlation window of pixel values;
choose a normalized damping factor set;
compute a quantization alignment offset;
align a current image of an animation with the quantization alignment offset;
align a one or more diffusion images of an animation with the quantization alignment offset;
compute a quantum correlation matrix for the pixels in the current image;
convert the quantum correlation matrix for the pixels in the current image into a plurality of temporal diffusion weights;
normalize the quantum correlation matrix;
perform spatial and temporal diffusion on the current image; and
display an image of the animation based on the diffused current image.

12. The method of claim 11 wherein aligning the current image using the quantization alignment offset comprises subtracting the QAO from the value of each pixel in the current image.

13. The electro-optic display of claim 11 wherein aligning the one or more diffusion images of an animation using the quantization alignment offset comprises subtracting the quantization alignment offset from the value of each pixel in the one or more diffusion images.

14. The electro-optic display of claim 11 wherein computing the quantum correlation matrix for each pixel in the current image comprises cross-correlating the patch of pixel values with the correlation window of pixel values.

15. The electro-optic display of claim 11 wherein to compute the quantization alignment offset the controller is further configured to:
compute a pixel alignment offset for each pixel in the current image; and
determine the mean of the pixel alignment offset for each pixel in the current image.

16. The electro-optic display of claim 15 wherein to compute the pixel alignment offset the controller is further configured to:
compute a first sum comprising:
(i) the product of a first quantization state value and a first factor of the normalized damping factor set, and
(ii) the product of a second quantization state value and a second factor of the normalized damping factor set; and
divide the first sum by the sum of the first and second factors of the normalized damping factor set.

17. The electro-optic display of claim 11 wherein the size of the patch of pixel values is smaller than the size of the correlation window of pixel values.

18. The electro-optic display of claim 11 wherein the normalized damping factor set includes a first factor corresponding to a first quantization state value, and a second factor corresponding to a second quantization state value.

19. The electro-optic display of claim 18 wherein the first factor is less than the second factor.

20. The electro-optic display of claim 18 wherein the first quantization state value is less than the second quantization state value.
